(19) United States
(12) Patent Application Publication
(10) Pub. No.: US 2005/0261939 A1
(43) Pub. Date: Nov. 24, 2005

(54) Pharmacy benefits calculator

(75) Inventors: Kristen R. Augspurger, Louisville, KY (US); Sarah A. Stephens, Louisville, KY (US); Michael A. Karrer, Louisville, KY (US); Kennon L. Vinson, Louisville, KY (US); Mark A. Flinchum, Louisville, KY (US); Inessa Kallik, Louisville, KY (US); Megan K. Elizabeth, Louisville, KY (US); Elizabeth M. Warren, Louisville, KY (US); William K. Fleming, Prospect, KY (US); Jonathan T. Lord, Louisville, KY (US)

Correspondence Address: Markets, Patents & Alliances LLC, 30 Glen Terrace, Stamford, CT, 06906-1401, US

(73) Assignee: Humana Inc.

(21) Appl. No.: 11/127,857

(22) Filed: May 12, 2005

Related U.S. Application Data
(63) Continuation-in-part of application No. 11/119,125, filed on Apr. 29, 2005.
(60) Provisional application No. 60/572,586, filed on May 19, 2004.
(60) Provisional application No. 60/601,918, filed on Aug. 16, 2004.

(51) Int. Cl. G06F 17/60

(52) U.S. Cl. 705/2; 705/4

(57) ABSTRACT

A Pharmacy Benefits Calculator reads in an insured's prior pharmacy claims history and then calculates said insured's anticipated out-of-pocket costs for one or more pharmacy benefits plans that said insured is eligible to enroll in. Provision is made for an insured to modify their anticipated future pharmacy needs. Provision is also made for an insured to compare their out-of-pocket costs for different alternative drugs, said alternative drugs providing comparable therapeutic benefits. Provision also is made for an insured to substitute a lower cost generic equivalent for a brand drug, when available. Another provision is made for an insured to choose to price drugs at a retail pharmacy store or a mail order pharmacy and determine cost differences. The pricing available from said retail pharmacy store may be based on a price negotiated by an insurance company offering said pharmacy benefits plans.

### CROSS-REFERENCE TO RELATED APPLICATION

This application is a continuation-in-part and claims the benefit of the filing date of US nonprovisional patent application Ser. No. 11/119125 filed Apr. 29, 2005, entitled “Pharmacy Benefits Design”, agent docket HM030504USNP, and with inventors Elizabeth M. Warren et al. Said nonprovisional application is incorporated herein by reference.

Said nonprovisional application entitled “Pharmacy Benefits Design”, in turn, claims the benefit of the filing date of U.S. provisional patent application Ser. No. 60/568,517, filed May 6, 2004, and entitled “Pharmacy Benefits Design”. Said provisional application is incorporated herein by reference.

Said nonprovisional application entitled “Pharmacy Benefits Design” also claims the benefit of the filing date of U.S. provisional patent application Ser. No. 60/572,586, filed May 19, 2004, and entitled “Pharmacy Benefits Calculator”. The instant application also directly claims the benefit of the filing date of said U.S. provisional patent application Ser. No. 60/572,586. Said provisional application is incorporated herein by reference.

Said nonprovisional application entitled “Pharmacy Benefits Design” also claims the benefit of the filing date of U.S. provisional patent application Ser. No. 60/601,918, filed Aug. 16, 2004, and entitled “Pharmacy Personal Care Account”. The instant application also directly claims the benefit of the filing date of said U.S. provisional patent application Ser. No. 60/601,918. Said provisional application is incorporated herein by reference.

### FIELD OF THE INVENTION

The invention is in the field of health insurance.

### BACKGROUND

One of the challenges that a consumer faces in controlling their out-of-pocket health care costs is selecting an appropriate health insurance plan. Very often the most economical plan depends upon the particular personal situation of said given consumer.

Online calculators have been provided to help a consumer compare their out-of-pocket costs for different health insurance plans. These calculators provide web pages to a consumer. Said consumer provides generic personal information to said web pages, such as age and residence. The information systems providing said web pages then assign said consumer to a given demographic category based on the generic personal information provided. The information systems then provide average health care costs of other consumers in the said assigned demographic category. The average health care costs may be broken down by type of cost, such as doctor visits and pharmaceutical costs. Said consumer may then determine what the out-of-pocket costs of different health insurance plans available to him/her might be, based on the assumption that their costs will be similar to the average costs. The consumer can then make a choice of which of said health insurance plans is most appropriate to his/her needs.

A significant limitation of the above described online calculators is that for some health insurance plans, the above described method of projecting future health care costs for a given person based on the average health care costs of persons of the same demographic category are very inaccurate. For example, many health insurance plans provide coverage for pharmaceutical costs. Pharmaceutical costs of different persons in the same demographic category can vary substantially depending upon the particular pharmaceuticals each of said different persons is taking. Generic antibiotics, for example, might only cost $15 per script. AIDS drugs might cost $100 per script. Different persons in the same demographic category might be taking one drug or the other. There is a long felt need, therefore, for a calculator than can provide a more accurate projection of a given consumer's anticipated out-of-pocket healthcare costs under different health insurance plans.

### SUMMARY OF THE INVENTION

The Summary of the Invention is provided as a guide to understanding the invention. It does not necessarily describe the most generic embodiment of the invention or all species of the invention disclosed herein.

The present invention is a method and apparatus for providing a Pharmacy Benefits Calculator. The method comprises providing web pages to prospective insureds. Prospective insureds are also referred to herein as “users”. At least one of said web pages comprises a table indicating expected pharmacy scripts to be purchased by a prospective insured for an upcoming year or other appropriate term. Said table also indicates the anticipated out-of-pocket costs for said scripts for one or more alternative pharmacy benefits plans available to the prospective insured.

The present invention is useful for helping prospective insureds decide among alternative pharmacy benefits plans offered by their employer during an open enrollment period for their health care coverage. An open enrollment period might be a particular month during a given year whereby an employee of a company is free to change the options of their health care coverage without paying a penalty.

The present invention may comprise a method and apparatus for displaying a prospective insured's prior prescriptions and associated out-of-pocket costs. The prior prescriptions and their associated out-of-pocket costs are useful for projecting the future prescription costs of said prospective insured.

The present invention may comprise a method and apparatus for allowing a prospective insured to input their anticipated prescriptions for an upcoming plan year so as to more accurately project their anticipated pharmaceutical costs.

The present invention may comprise a method and apparatus for proposing alternative drugs and their anticipated costs to a prospective insured. Said alternative drugs may be generic equivalents and/or have the same therapeutic classification as a given drug but have lower out-of-pocket costs. This is useful for providing information to a prospective insured so that they can discuss the suitability of said alternative drugs with their physician so that said prospective insured can get effective treatment at lower out-of-pocket costs.

The present invention may comprise a method and apparatus for allowing an insured to view the records of their specific pharmaceutical purchases throughout a give plan year. This is useful for allowing an insured to reforecast and manage their pharmacy costs within said plan year.

### BRIEF DESCRIPTION OF THE DRAWINGS

FIG. 1A is the first portion of a storyboard illustration of the steps one embodiment of the present invention for providing the estimated out-of-pocket costs of one or more pharmacy benefits plans to a given user.

FIG. 1B is a continuation of said storyboard illustration.

FIG. 2 is a Pharmacy Benefits Calculator physical architecture diagram.

FIG. 3A illustrates the data fields stored in certain databases or web pages used in the method of the present invention.

FIG. 3B illustrates the data fields stored in additional databases used in the method of the present invention.

FIGS. 4 to 26 illustrate the contents of web pages that would be presented to a user who is using a Pharmacy Benefits Calculator in one embodiment of the present invention.

FIG. 4 is a “Welcome” page.

FIG. 5 is an “Open My Saved List” page.

FIG. 6 is a “Printable Drug Lists' page.

FIG. 7 is a “My Rx List: New Member” page.

FIG. 8 is a “My Rx List: Current Member but not Prior Claims” page.

FIG. 9 is a “My Rx List: Individual w/ Previous Claims” page.

FIG. 10 is a “My Rx List: Family w/ Previous Claims” page.

FIG. 11 is an “Rx Calculator Tips” pop-up.

FIG. 12 is a “My Claims Detail: Individual” page.

FIG. 13 is a “My Claims Detail: w/ Dependents” page.

FIG. 14 is an “Add a Drug: Search” page.

FIG. 15 is an “Add a Drug: Selection” page.

FIG. 16 is an “Add a Drug: Usage Details” page.

FIG. 17 is a “My Rx List: w/ Added Drugs” page.

FIG. 18 is a “Save My List” page.

FIG. 19 is a “Compare Plans: Compare Plan Costs” page.

FIG. 20 shows the “Compare Plans” pop-ups.

FIG. 21 is a “Compare Plans: Rxlmpact Pricing Details” page.

FIG. 22 is a “Compare Plans: HDHP Pricing Details” page.

FIG. 23 is an “Alternatives Pricing” page with the “Rxlmpact Pricing Details” tab selected.

FIG. 24 shows the “Alternatives” pop-up.

FIG. 25 is a “Goodbye: Take Totals Back” page.

FIG. 26 is a “Goodbye: Pick a Product” page.

### DETAILED DESCRIPTION

The following detailed description discloses various embodiments and features of the invention. These embodiments and features are meant to be exemplary and not limiting.

### Definitions

The definitions provided below are to be applied to their respective terms or phrases as used herein unless the context of a given particular use of a given term or phrase clearly indicates otherwise.

The terms “health insurance”, “health care plan”, or “benefit plan” refer to an insurance plan that pays benefits to an insured in the event that said insured incurs covered medical costs.

The term “pharmacy benefits plan” or the like refers to an insurance plan that provides benefits to an insured for their covered pharmacy costs. A pharmacy benefits plan may be a subset of a given health insurance plan. A pharmacy benefits plan may also be a stand-alone insurance policy.

The term “plan year” refers to an annual period for which a given health care plan is in force.

The term “Enrollment Event” refers to a period of time that a prospective insured can select their health care plan for an upcoming plan year.

The term “insured” refers to a person who is covered by an insurance policy, such as a health insurance policy.

The term “prospective insured” refers to a person who is considering enrolling in a given insurance plan.

The term “member” refers to a person who is already covered by an insurance policy provided by a given insurance company.

The term “user” refers to a person using a Pharmacy Benefits Calculator.

The term “benefit” or the like refers to money or other consideration provided by an insurance company to an insured as compensation for a covered event.

The phrase “out-of-pocket costs”, the abbreviation “OOP”, or the like refer to the portion of an insurance claim that is not covered by a pharmacy benefits plan. Said portion would have to be paid by an insured out of their own pocket.

The term “Health Plan Wizard” refers to one or more web pages or the like that a prospective insured would use to enroll in a given health insurance plan.

The terms “Pharmacy Benefits Calculator” and “Rx Calculator” refer to set of one or more web pages or the like which employ the present invention for calculating and displaying the anticipated out-of-pocket pharmacy costs to a given prospective insured under one or more pharmacy benefits plans.

The term “cost” refers to the sale price of a particular item in question, such as a pharmacy script.

The terms “script”, “prescription”, “pharmacy script” and the like refer to “an order” for a given quantity of a given drug.

The phrase “Average Wholesale Price” and the abbreviation AWP, refers to a national average wholesale price for a given drug at a given time. Proprietary lists of average wholesale prices are published by pharmacy data companies, such as First DataBank of San Bruno, Calif.

The phrase “Estimated Retail Price” is an estimated cost that that an insured would be charged for a given script if said insured did not have any insurance coverage for said given script. The estimated retail price can be calculated from an average wholesale price by multiplying the average wholesale price by a discount. The discount may represent the average discount that an insurance company is able to negotiate with a retail pharmacy chain, such as Wal-Mart Stores, Inc. of Bentonville, Ark. The estimated retail price may be additionally adjusted by a small factor such that the exact price negotiated with a given retail pharmacy chain is not immediately apparent from the estimated retail price shown to a prospective insured. Said small factor is selected such that the estimated price still substantially retains it's utility as an estimate of the actual out-of-pocket costs that a user might experience, but the confidentiality of a given discount is preserved. Said small factor may, for example, be an offset in price in the range of 1% to 10%.

The actual cost of a script that a given insured may pay for a given script may be different than the estimated retail price. The actual costs may vary by pharmacy and by the specific quantity, strength and/or dosage of the medication. An insured may not learn their actual cost until they fill a prescription.

The term “information system” or the like refers to one or more of computers, servers, input devices, output devices, data storage devices, telecommunications equipment and software. Information systems may communicate with other information systems via telecommunications means, such as the Internet.

Information systems may also communicate with persons via input/output devices. Persons may communicate with other persons using information systems.

Monetary quantities disclosed herein are in US dollars as of May 2005. Said quantities may be converted to other currencies at other times using published exchange rates and appropriate inflation factors. An appropriate inflation factor would be the inflation of the average cost of pharmacy scripts.

The term “personal confidential information” refers to information about a person that is not freely available to the public.

The terms “Group”, “level” or “tier” refer to a category assigned to a given script under a given Pharmacy Benefits Plan. Said category is used to determine the coverage of a given script under a given Pharmacy Benefits Plan. “Groups” are generally used with respect an Rxlmpact plan or other plan based on allowances for a given script. “Level” or “tier” are generally used with respect to a copay plan.

### Method for Providing a Pharmacy Benefits Calculator

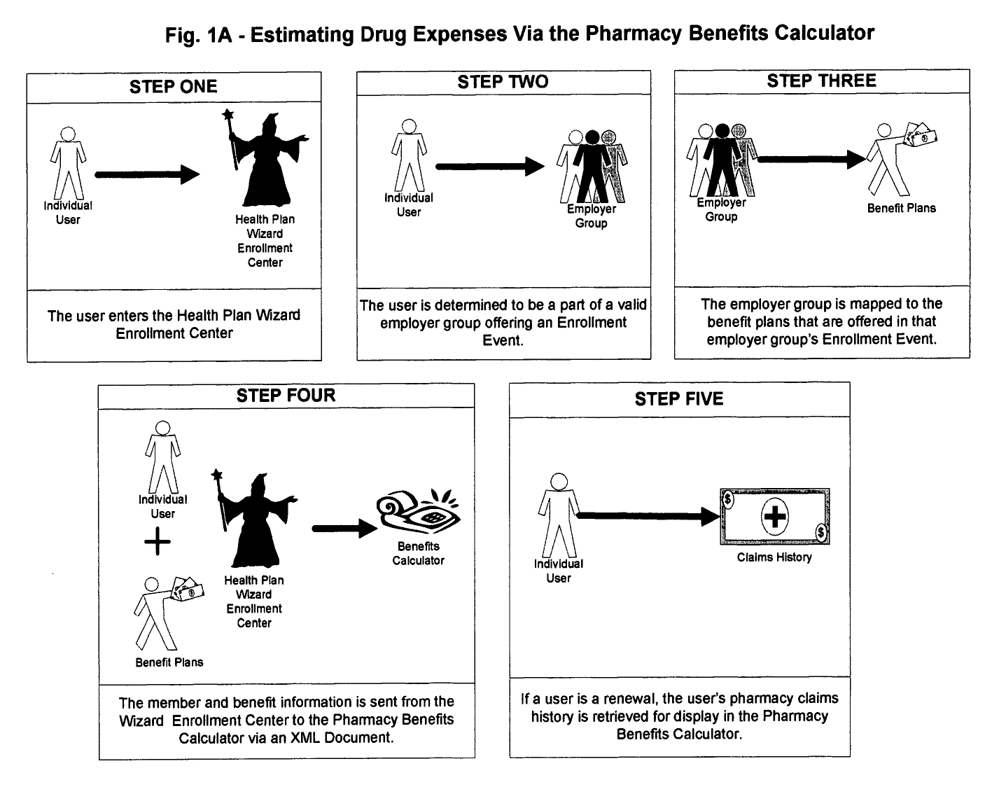

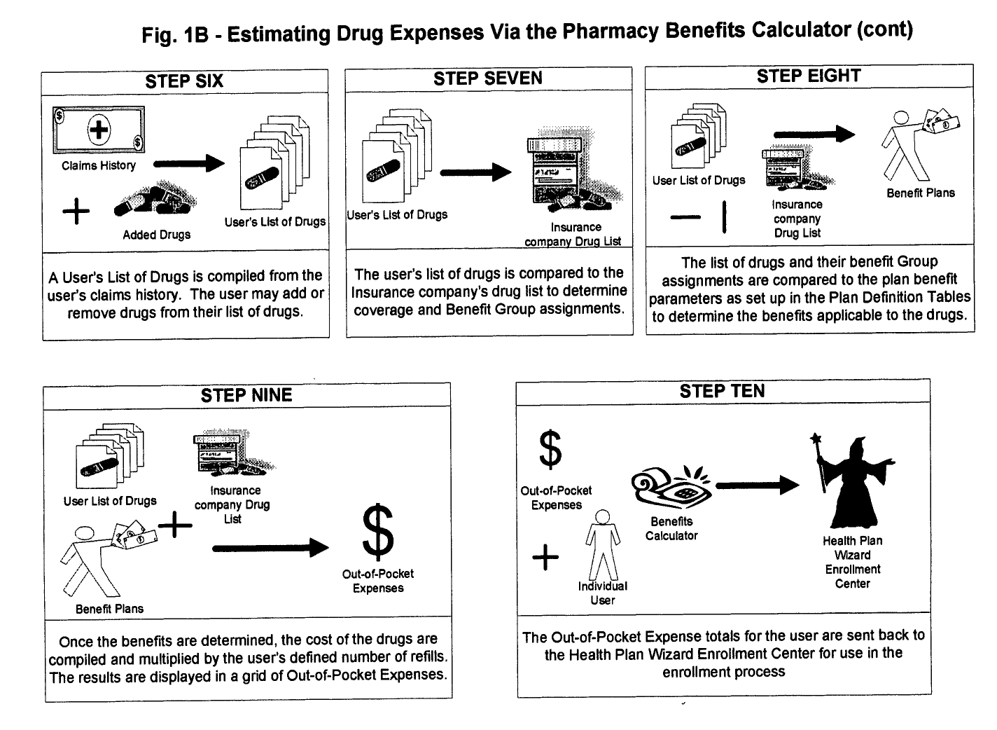

An exemplary method for providing a user with an estimate of their anticipated out-of-pocket pharmacy costs for an upcoming plan year is illustrated in FIGS. 1A and 1B. Said Figures show a storyboard describing the interactions between an individual user and an information system providing a Pharmacy Benefits Calculator. Said interaction may be via a Web interface.

The description of the steps of the method presented in said storyboard are to be understood in the context of a person interacting with one or more web pages provided by one or more information systems. For example, the phrase “The user enters the Health Plan Wizard Enrollment Center” of step 1 of said storyboard would be understood by a person of ordinary skill in the art as meaning:
said user enters a URL corresponding to said Health Plan Wizard Enrollment Center into a work station connected to the Internet or other appropriate telecommunications means;
said workstation transmits a first electronic, optical or other physical signal to said one or more information systems,
said first signal then causes said one or more information systems to compose a second electronic, optical or other physical signal, said second signal being adequate to cause said workstation to display said first page of said Health Plan Wizard Enrollment Center;
said one or more information systems then transmits said second signal to said workstation;
said workstation then receives said second signal from said one or more information systems; and
said second electronic signal causes said workstation to display said first page of said Health Plan Wizard Enrollment Center.

Refer to FIG. 1A unless otherwise indicated.

The method thus comprises the following steps:

Step One: the User Enters the Health Plan Wizard Enrollment Center

A user may gain access to a Pharmacy Benefits Calculator by first entering a Health Plan Wizard Enrollment Center. A Health Plan Wizard Enrollment Center is a Web enabled means by which said user may enroll in a given health insurance plan offered by the employer of said user. The Heath Plan Wizard may be provided by an insurance company or other entity authorized to present personal health information to said user.

In order to enter the Health Plan Wizard, a user provides identification and security information. Said identification and security information may comprise a user name and password. Said identification and security information may alternatively comprise the name of said user, the social security of said user, the date of birth of said user and other personal information of said user. If the name, social security number, date of birth and other personal information exactly match the corresponding information stored in the Health Plan Wizard, then the user is granted access to their personal medical history information and other confidential information appropriate to using the Health Plan Wizard.

Provision may be made to allow access to secure information if the user does not provide exact security information. For example, it may be adequate that the person spell their last name exactly, but only specify the first three letters of their first name correctly.

Provision may also be made for a manual override of the security requirements. For example, a call-in number may be provided so that users who have difficulty accessing their personal confidential information can call into a help center and obtain the information they need to correctly access the Health Plan Wizard. If a user called in, for example, and it was determined that they were entering their common name or nick name as opposed to their legal name, they might be reminded to enter their legal name.

Alternatively, a Health Plan Wizard may merely be a means for accepting identification and security information from a user and processing said information in order to determine if said user can be granted access to his/her personal medical history information.

Step Two: the User is Determined to be Part of a Valid Employer Group offering an Enrollment Event.

Once the information system offering the Health Plan Wizard verifies that the user has access to their personal confidential information, said information system then checks one or more data bases to determine if said user belongs to an employer group that is currently offering an Enrollment Event.

An Enrollment Event is a period of time whereby the employees of a given employer group may select from one or more health insurance options that are offered by said employer. Said period of time is typically a month. Enrollment Events are typically offered annually. There are often changes in health insurance plans on an annual basis. A Health Plan Wizard is useful for, explaining the changes to the available health care plans, guiding an employee through the options that are available to him/her and providing a means for said employee to select one of those options.

If it is determined that there is currently no Enrollment Event for said user, said user may nonetheless be given access to tools within the Health Plan Wizard, such as a Pharmacy Benefits Calculator. As is more fully described below, a Pharmacy Benefits Calculator has surprising utility for helping a member manage their pharmaceutical expenses throughout a plan year.

Step Three: the Employer Group is Mapped to the Benefit Plans that are Offered in that Employer Group's Enrollment Event.

Groups may have one or more health insurance options available to them. This may or may not include one or more prescription benefit options. Different groups of employees employed by a given employer may have different health insurance options available to them. A manufacturer, for example, may have one set of health insurance plans available for its unionized employees and another set of health insurance plans available for its non-unionized employees.

Step Four: the Member and Benefit Information is Sent from the Wizard Enrollment Center to the Pharmacy Benefits Calculator via an XML Document.

The information system running the Health Plan Wizard has access to the member information and benefit information of a given user. “Member information” comprises identity information of a user. “Benefit information” comprises information on past benefits paid to settle claims against a health insurance policy in force on said user.

The member information and benefit information are passed on to the Pharmacy Benefits Calculator so that the Pharmacy Benefits Calculator can perform its required functions based on a user's benefits.

Step Five: If a User is a Renewal, the User's Pharmacy Claims History is Retrieved for Display in the Pharmacy Benefits Calculator

A user is considered a renewal if the Pharmacy Benefits Calculator has access to their pharmacy claims history. If the Pharmacy Benefits Calculator has access to the pharmacy claims history of a given user's health insurance company, for example, and if the user was renewing their coverage with the same health insurance company, then the Pharmacy Benefits Calculator would have access to the claims history of said user and said user would be a renewal. Refer to FIG. 1B unless otherwise indicated.

Step Six: a User's List of Drugs and Total OOP Costs are Compiled from the User's claims history. the user may add or Remove Drugs from their list of Drugs.

As discussed in more detail below, a feature of a Pharmacy Benefits Calculator is that a user may be provided with a list of drugs that they and their dependents under 18 (if applicable) bought in the past plan year. Said list of drugs is a good indicator of said user's anticipated drug usage in the upcoming plan year. Said list of drugs is determined from the claim history of said user. Said user is also provided with total OOP $ amounts for all family members (if applicable) on his/her health insurance plan. This will assist said user with determining how much he/she may anticipate spending in the new plan year.

Another feature of a Pharmacy Benefits Calculator is that provision is made for said user to add or remove drugs from their drug list. A user might, for example, remove drugs that were prescribed for a short term acute condition, such as an infection, and keep only those drugs that are taken for a long term chronic condition, such as high blood pressure. Similarly, a user may add drugs that they anticipate they or their family members will be taking, such as pain medication for the recovery period of a scheduled operation.

Another feature of a Pharmacy Benefits Calculator is it will price drugs by both retail cost and mail order cost for the insured. The Pharmacy Benefits Calculator also allows said user the ability to compare pricing of a brand name drug versus possible generics and therapeutic alternatives.

Step Seven: the User's List of Drugs is Compared to the Insurance company's Drug List to Determine Coverage and Benefit Group Assignments.

One or more insurance companies providing health insurance plans to said employer group determines their drug lists, coverage and Benefit Group assignments available to the employees through the Pharmacy Benefits Calculator. Different employer groups may offer different coverage of different drugs for their employees. A copay plan, for example, may require the user to pay a fixed amount for a given drug depending upon the Benefit level/tier said drug is assigned to. A copay plan may require a higher copay, such as $40, for higher cost brand name drugs, and a lower copay, such as $25 for lower cost generic drugs. Therefore, the brand and generic drugs would be assigned to the appropriate Benefit level/tier.

Step Eight: the List of Drugs and their Benefit Group Assignments are Compared to the Plan Benefit Parameters as set up in the Plan Definition Tables to Determine the Benefit Coverage Applicable to the Drugs.

Plan Definition Tables comprise information required to determine how much of the cost of a drug is covered under a given health care plan. The amount of the cost of a drug that is covered may vary depending upon the particular plan chosen by a user. The amount of the drug cost remaining (if any) is the out-of-pocket cost to the member.

The term “benefits applicable to the drugs” as used above refers to the amount of a cost of a drug that is covered by a given health insurance plan.

Step Nine: Once Benefits are Determined, the cost of the Drugs are Compiled and Multiplied by the user's Defined Number of fills and/or refills. The Results are Displayed in a Grid of the Out-of-Pocket Expenses.

A given set of drugs may have very different out-of-pocket expenses for a given user under different Rx Benefit plans. These different out-of-pocket expenses are displayed to the user in the Pharmacy Benefits Calculator, so that the user may take the anticipated out-of-pocket expenses into account when selecting which health insurance plan to enroll in.

Step Ten: the Out-of-Pocket Expense Totals for the User are Sent Back to the Health Plan Wizard Enrollment Center for use in the Enrollment Process.

This embodiment of the invention comprises a Pharmacy Benefits Calculator being offered as a means to help a user select from one or more health insurance plans during an Enrollment Event. In this case, the results of the calculation are sent back to the Health Plan Wizard so that the user may include pharmacy costs in their overall health care cost projections under different health insurance plans.

A Pharmacy Benefits Calculator has utility, however, apart from being offered during an Enrollment Event. A user, for example, may access a Pharmacy Benefits Calculator during a plan year to track their ongoing prescription drug expenses. Provision must be made, however, for making sure that said user satisfies the security requirements provided for by law or policy governing said user's access to their personal confidential information.

### Pharmacy Benefits Calculator Physical Architecture

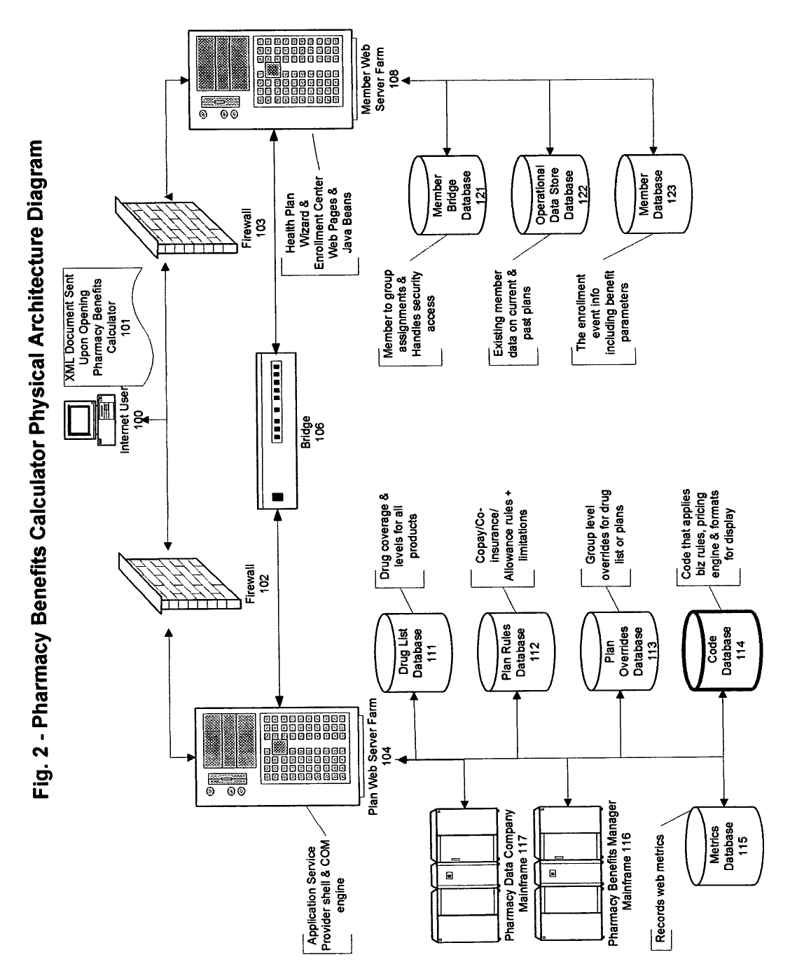

The physical architecture of an information system suitable for providing a Pharmacy Benefits Calculator to a number of users is illustrated in FIG. 2.

Text with a single square bracket to the right and a line pointing to an item in a given Figure of the instant application represents comments and/or identifying numbers for said item.

Said information system comprises one or more web server farms, 104 and 108. Said web servers farms comprise one or more computers, software and telecommunications equipment suitable for providing web pages 101 to one or more Internet Users 100. Firewalls 102 and 103 may be provided to reduce the occurrence of malicious access to said web server farms. A bridge 106 may be provided to facilitate high-speed secure data transfer between web server farms.

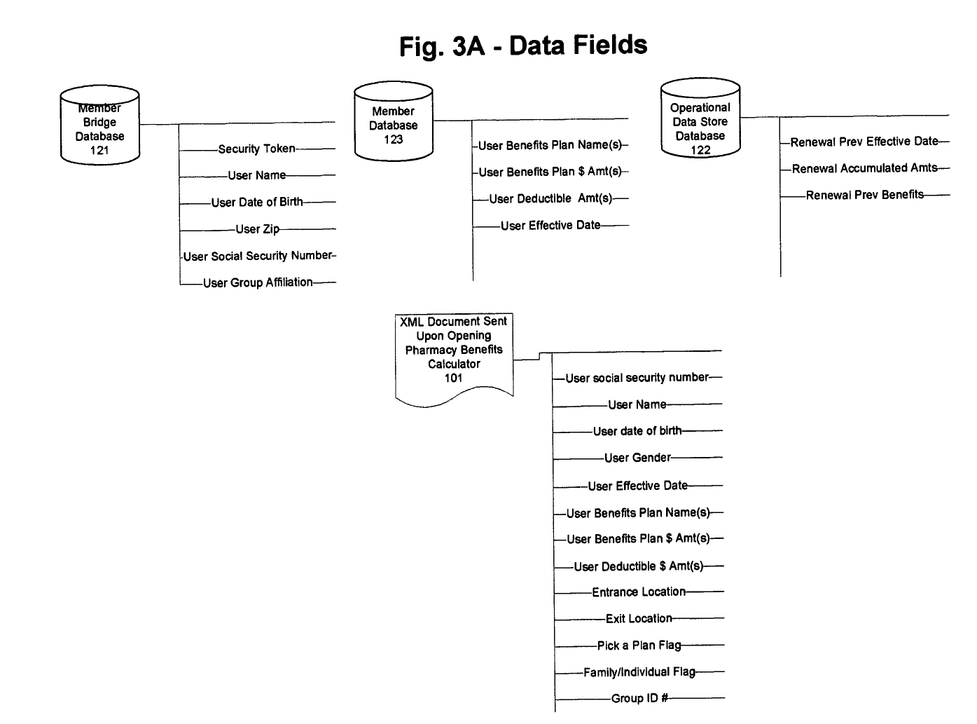

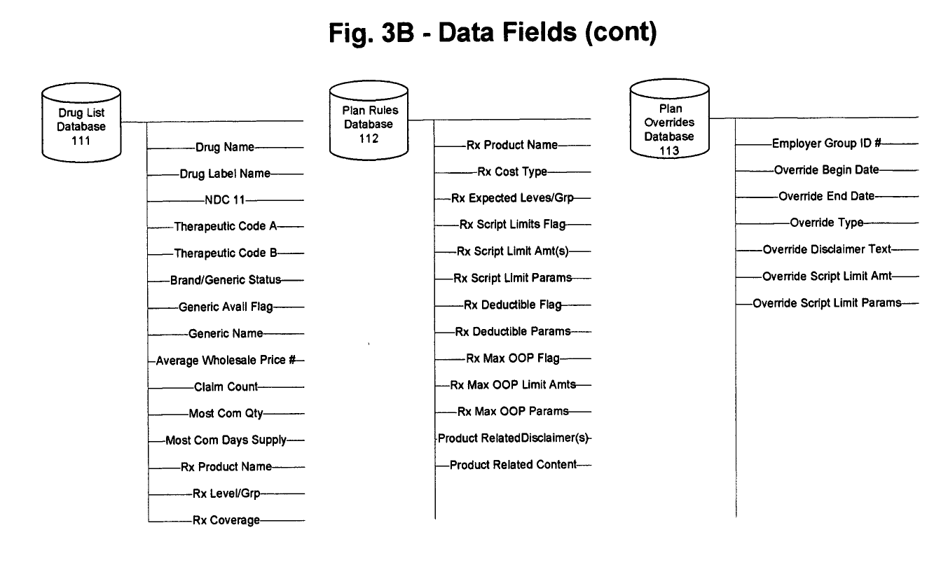

The data required to compose one or more web pages of a Pharmacy Benefits Calculator may reside on one or more databases. Said databases are shown conceptually in FIG. 2 as items 111, 112, 113, 114, 115, 116, 121, 122, and 123. The fields of data stored several of said databases are shown in FIGS. 3A and 3B.

Said databases are shown as separate physical entities for the sake of convenience of explanation. Any subset of said entities may physically reside on the same database server. Any given one of said entities may alternatively physically reside on multiple separate database servers.

Nonetheless, the physical architecture illustrated in FIG. 2 creates surprising utility for a Pharmacy Benefits Calculator when said Calculator is provided to a set of 1,000 or more users during a given Enrollment Event.

For example, by providing a separate code database 114 operated by a high-speed processor, the particular physical architecture illustrated can provide web pages with a high speed and enhanced security relative to having said web pages composed on one of the server farms 104 or 108. Said database processor comprises instructions for composing a given web page of a Pharmacy Benefits Calculator for a given user. Said processor accesses the required code from the code database 114 and the other required data from the other databases shown in FIG. 2. The composed web page is then transmitted to at least one of said web server farms where it is forwarded to said user 100.

The overall speed and capacity of the physical architecture is selected such that a given user will have a given web page presented on their workstation within 10 seconds of entering a command. Preferably the delay is less than three seconds.

Having web pages of a Pharmacy Benefits Calculator composed individually using code elements stored in the code database 114 provides surprising utility in the administration of a Pharmacy Benefits Calculator. For example, unanticipated changes in the availability of a given drug require fast changes in the content of various pages in a Pharmacy Benefits Calculator. By storing the elements of code used to compose said pages in said code database 114, the process of updating said pages can be reduced from days to minutes.

There is a surprising benefit to retrieving pharmacy claims data from a pharmacy benefits manger mainframe 116. Pharmacy benefits managers process pharmacy claims in real time. Hence the claims data on a pharmacy benefits manager's mainframe will be current to within a few seconds. When a user uses a Pharmacy Benefits Calculator, their records will be current to within a few seconds. Users have found the system to be so fast that they may use the Pharmacy Benefits Calculator as a means to determine if a given prescription that they recently submitted to a pharmacy is ready to be picked up. After they submit their prescription to a pharmacy, they launch the Pharmacy Benefits Calculator, pull up their current pharmacy claims and check to see if a record for a new claim has shown up for the prescription they just dropped off.

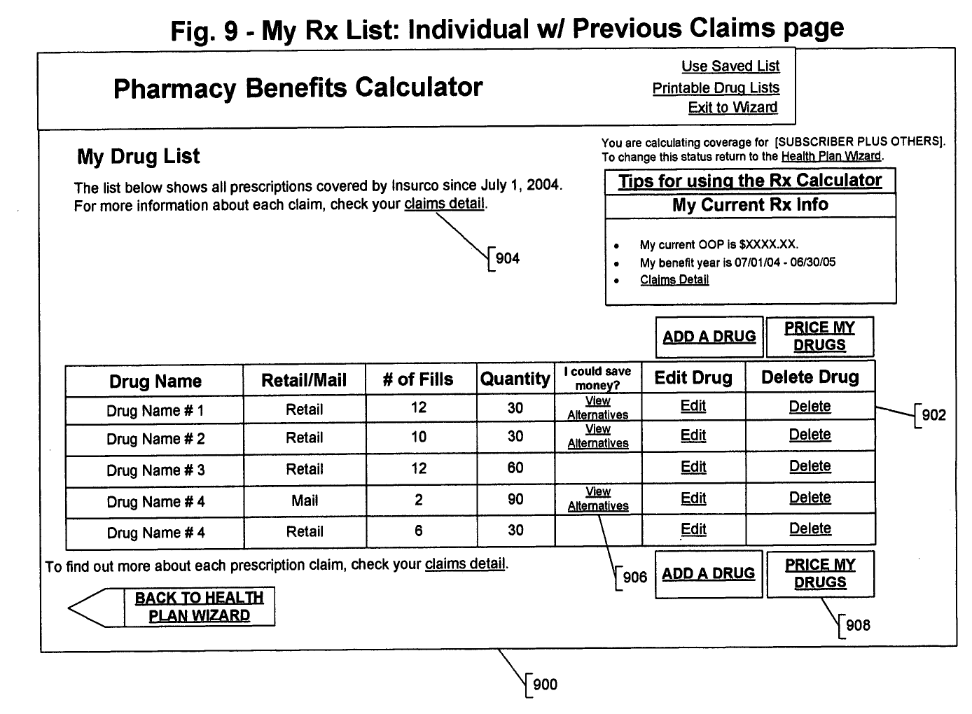

The metrics database 115 provides surprising utility for improving a given version of the Pharmacy Benefits Calculator. The metrics database comprises data on how frequently different features of the Pharmacy Benefits Calculator are used. If a given feature is underutilized, it may be modified to increase its utility. Administrators of the Pharmacy Benefits Calculator can monitor the usage of a given feature after it is modified to see of the modification was effective. For example, in an early version of the Pharmacy Benefits Calculator, it was found that users where not using the feature of looking up lower cost alternatives to a given drug as frequently as was hoped. In response, the table 902 (FIG. 9) of drugs presented to a user was modified to have a column that asked the question “I could save money?” and links labeled “View Alternatives” were provided in the cells of said column when lower cost generic or therapeutic alternatives were available for a given drug. As a consequence, users significantly increased their use of the feature for looking up lower cost alternatives.

Referring to FIGS. 3A and 3B, the names of the data fields illustrated in FIGS. 3A and 3B are generally self-explanatory to a person of ordinary skill in the art. Certain terms are explained more fully below.

“Entrance Location” and “Exit Location” fields refer to what web page a user entered the Pharmacy Benefits Calculator from and what page a user of a Pharmacy Benefits Calculator will exit to respectively.

“Pick a Plan Flag” refers to an indicator of whether or not a user must pick a pharmacy benefits plan before they exit a Pharmacy Benefits Calculator.

“NDC 11” refers to the 11 digit national drug code assigned to a given script by the US FDA.

The Drug List Database 111 comprises information that can be used to, at least in part, determine a suitable generic or therapeutic alternative to a given drug. Said information is also useful for estimating the out-of-pocket costs that a given user may be required to pay for a given script.

The Drug List Database comprises a first set of data which is read in from a pharmacy data company, such as First Databank of San Bruno Calif., and a second set of data which is read in from a pharmacy benefits manager, such as Caremark Rx, Inc. of Nashville, Tenn. Said first and second sets of data are preferably updated at a frequency of once per week or greater.

Said first set of data read in from a pharmacy benefits manager comprises at least a drug identifier, such as NDC 11, Drug Name or Drug Label Name, and at least one of a “drug usage data field”, such as claim Count, Most Corn Qty, Most Corn Days Supply, Rx Product Name, Rx Level/Grp or Rx Coverage.

“Claim Count” refers to the number of claims for a given drug made by members of a given reference employee group. “Most Com Qty” refers to the most common number of units of a given drug ordered by said members of said given reference employee group. “Most Corn Days Supply” refers to the most common number of days supply for fills of a given drug. “Rx Product Name” refers to the Pharmacy Benefits Plan associated with said members. “Rx Level/Grp” refers to the level/tier or Group that said drug belongs to in said Rx Product. Said level/tier or Group indicates the amount of Benefits paid for said drug according to said Rx Product. “Rx Coverage” indicates whether or not said drug is covered by said Rx Product.

Said first set of data read in from a pharmacy benefits manager is used, at least in part, to determine the appropriate number of units per fill of a generic or therapeutic alternative drug, said drug being a generic or therapeutic alternative to an associated brand name drug. This information is needed to estimate the anticipated out-of-pocket costs of said generic or therapeutic alternative drug.

The ability to make said estimate is a surprising result since the prior art does not disclose a direct relationship between the appropriate number of units required for a generic or therapeutic alternative drug given the number of units for given fill of an associated brand name drug. By reading in the data from a pharmacy benefits manager on the most common quantities of both a given brand name drug and an associated generic or therapeutic alternative drug, however, one can at least make a reasonable estimate of the likely number of units of a generic or therapeutic alternative drug that would be prescribed as an alternative to an associated brand name drug. Said estimate is reasonable in the sense that it will help a given user anticipate his/her out-of-pocket costs for a generic or therapeutic alternative drug. The actual number of units of a generic or a therapeutic alternative drug prescribed by a physician will depend upon the particular condition of the user or their family member (if appropriate) being treated.

Said second set of data read in from a pharmacy data company comprises at least one drug identifier, such as Drug Name, Drug Label Name or NDC 11, and at least one field of “drug market data”, such as Therapeutic Code A, Therapeutic Code B, Brand/Generic Status, Generic Avail Flag, Generic Name, or Average Wholesale Price #.

“Therapeutic Code A” refers to a therapeutic code assigned to a given drug under a first classification scheme A. “Therapeutic Code B” refers to a therapeutic code assigned to a given drug under a second classification scheme B. “Brand/Generic Status” refers to whether or not a given drug has been classified as “brand” or “generic” by a given pharmacy data company. “Generic Avail Flag” refers to whether or not a generic alternative is available for a given drug. “Generic Name” refers to the generic name of a given drug. “Average Wholesale Price #” refers to the average wholesale price of a given drug as determined by a pharmacy data company.

Said first therapeutic classification scheme A may cover a large fraction of the drugs in a given drug list, but with relatively broad therapeutic classification categories. Said second classification scheme B may cover a relatively small fraction said drugs but with more precise therapeutic classification categories. Said Therapeutic Codes may be used to determine the therapeutic alternatives to a given drug. Other drugs that have the same Therapeutic Code A or Therapeutic Code B of a given drug would be suitable therapeutic alternatives to a given drug. Different drugs with the same Therapeutic Code B would generally be closer matches than those that merely had the same Therapeutic Code A.

The Plan Rules Database 112 stores information relative to the adjudication of a given pharmacy script. The fields in said database would be those required to calculate the benefit levels and out-of-pocket costs of a given script for a given user under a given Pharmacy Benefits Plan. Said calculation of benefit levels is a simulation of the adjudication that will occur when said drug is actually purchased.

The Plan Overrides Database 113 stores information related to overrides to the standard terms of a given health care plan for a given set of insureds. For example, most of the employees of given company may have a pharmacy benefits plan that requires standard copays for a given drug. A subset of the employees might have copays different from said standard copays due to the outcome of, for example, collective bargaining. An override for said subset of employees would therefore be stored in database 113. Said override would specify said different copays for said subset of employees.

By using an Overrides Database, the total data storage capacity requirements for the Plan Rules Database can be reduced, the overall system speed can be increased and accurate drug cost information can be provided to both standard employees and subsets of employees.

By using at least a subset of the data available from the Drug List Database, Plan Rules Database and Plan Overrides Database (if needed), a Pharmacy Benefits Calculator can make a surprisingly accurate estimate of the actual out-of-pocket costs for a given user under a given one or more Pharmacy Benefits Plans. The system can also make out-of-pocket estimates for a large list of drugs, such as 500 drugs or more. The large list may also include a complete list of available drugs. Said complete list may comprise 10,000 drugs or more.

By providing out-of-pocket estimates for a complete or nearly complete list (e.g. 80% or more) of the drugs covered by a given Pharmacy Benefits Plan, the Pharmacy Benefits Calculator has a surprising increase in acceptance and utility among a large percentage of users. If the Drug List Database of a calculator only covered a relatively small number of drugs, such as 200 drugs or less, then a significant fraction of the users attempting to estimate their future out-of-pocket costs would likely have one or more drugs in their personal drug lists that were not available in the calculator. This would be the case even if the relatively small number of drugs found in a given Drug List Database were the most popularly prescribed drugs for a given set of users such that said relatively small number of drugs represented a large fraction (e.g. 50% or more) of the total drug expense of a given Pharmacy Benefits Plan.

If a Drug List Database comprised only a relatively small number of drugs, then one or two drugs of a given user's personal drug list would likely not be found in said Drug List Database. Said one or two drugs might represent a relatively large fraction of said user's out-of-pocket costs. Hence the Pharmacy Benefits Calculator would have reduced utility.

On the other hand, a Pharmacy Benefits Calculator would have markedly increased utility if at least 80% or more of all drugs covered by a Pharmacy Benefits plan were found in a more comprehensive Drug List Database such that there was a high probability that all of the drugs on any given user's personal drug list were found on said more comprehensive Drug List Database.

By similar reasoning, it is important to have the Drug List Database updated at least once per week. Drug lists may change on a daily basis. If the Drug List Database is only updated at a frequency of less than once per week, the number of incorrect fields would be sufficiently large that at any given time, a relatively large number of users would get incorrect or incomplete results. By updating at a frequency of once per week or greater, the Drug list is more accurate and the number of users that would obtain incomplete or incorrect information would be reduced.

### Pharmacy Benefits Calculator Web Pages

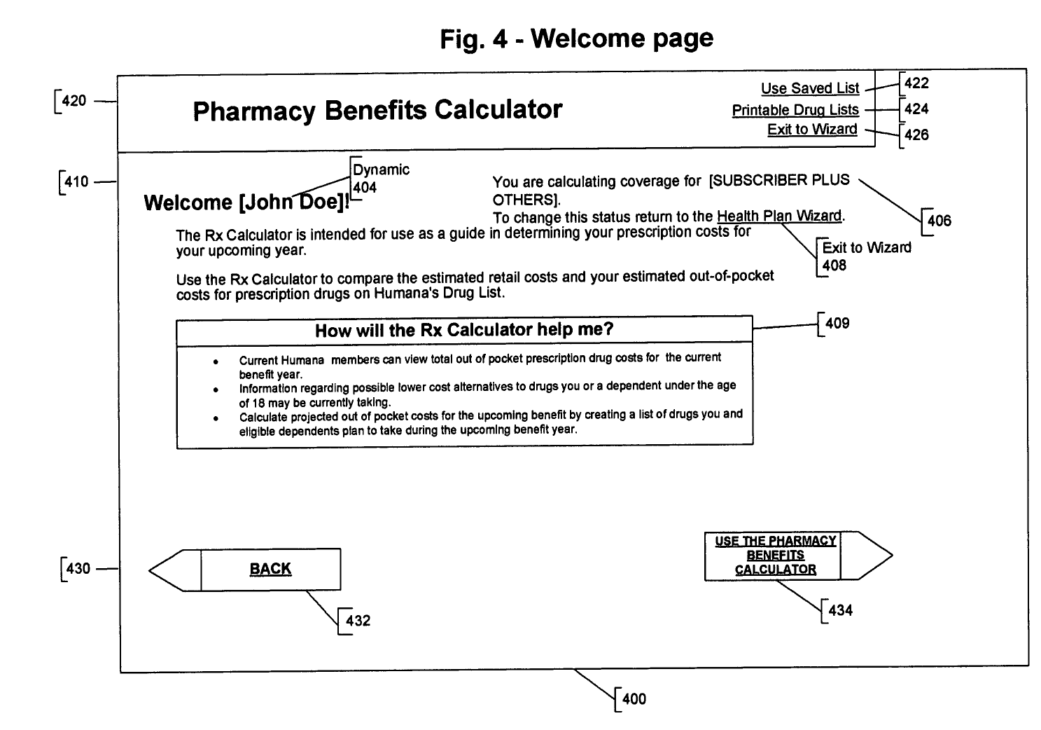

FIGS. 4 to 26 illustrate various web pages that would be presented to a user of a one embodiment of a Pharmacy Benefits Calculator.

Comments and item numbers are shown with a single square bracket to their right.

Dynamic text is shown between two square brackets. Dynamic text refers to text that is dependent upon the particular user using the Pharmacy Benefits Calculator or the other specific information. Element 404, for example is a field for the insertion of the name of the particular user. “John Doe” is shown by way of example.

“x”'s are shown for the digits of a number where the number a function of the user and other factors.

Hyperlinks and pop-ups are shown as underlined text. If a user clicks on a hyperlink, they will be taken to another web page. If they click on or rollover a pop-up, then a text box or other graphic will be displayed over the given web page they are viewing. The text box or graphic will disappear when they move their cursor away from a rollover link or if they click again.

Most web pages in this particular embodiment of a Pharmacy Benefits Calculator will comprise a header 420, body 410, and navigation buttons 430.

The header will generally comprise links 422, 424 and 426 which a user might be expected to want to use for most pages that they might be looking at. The links illustrated are “Use Saved List” 422, “Printable Drug Lists” 424, and “Exit to Wizard” 426.

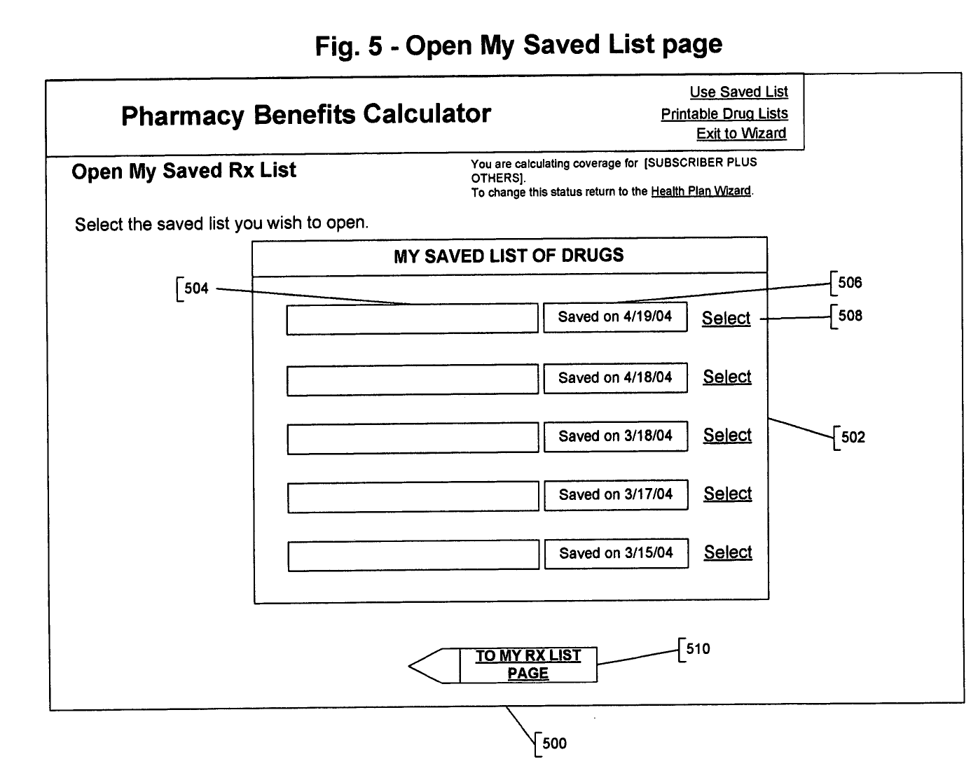

“Use Saved List” takes a user to the “Open My Saved List” page, FIG. 5. This page is used to retrieve a list of drugs said user has previously composed.

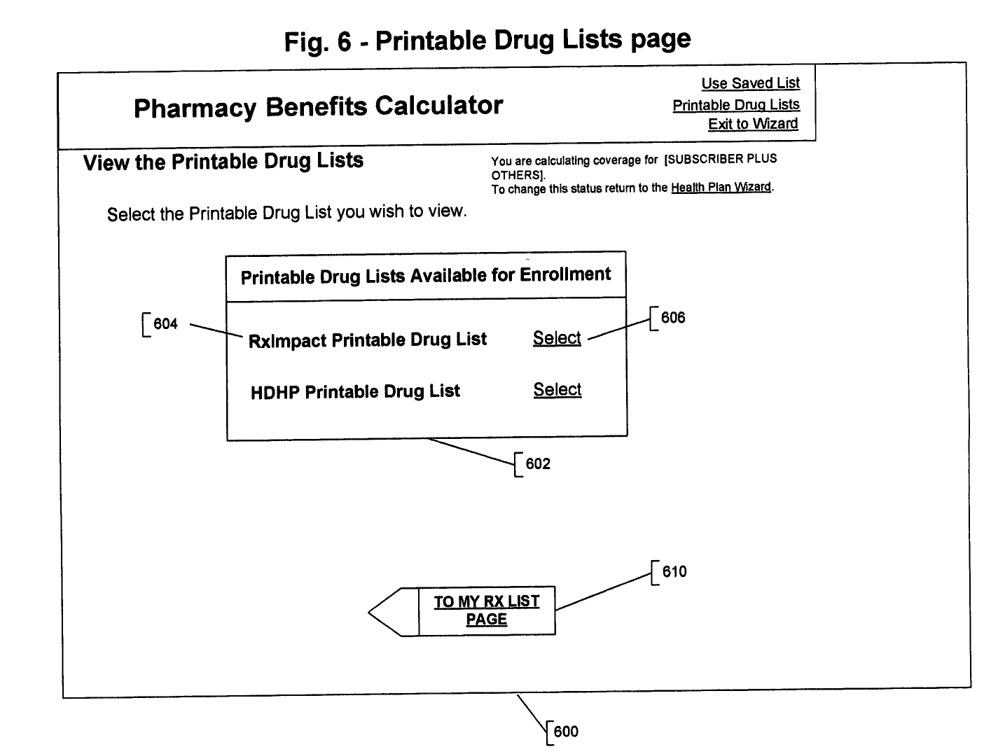

“Printable Drug Lists” takes a user to the “Printable Drug Lists” page, FIG. 6. This page is used to print a list of commonly prescribed drugs and their coverage levels under various health plans available to said user.

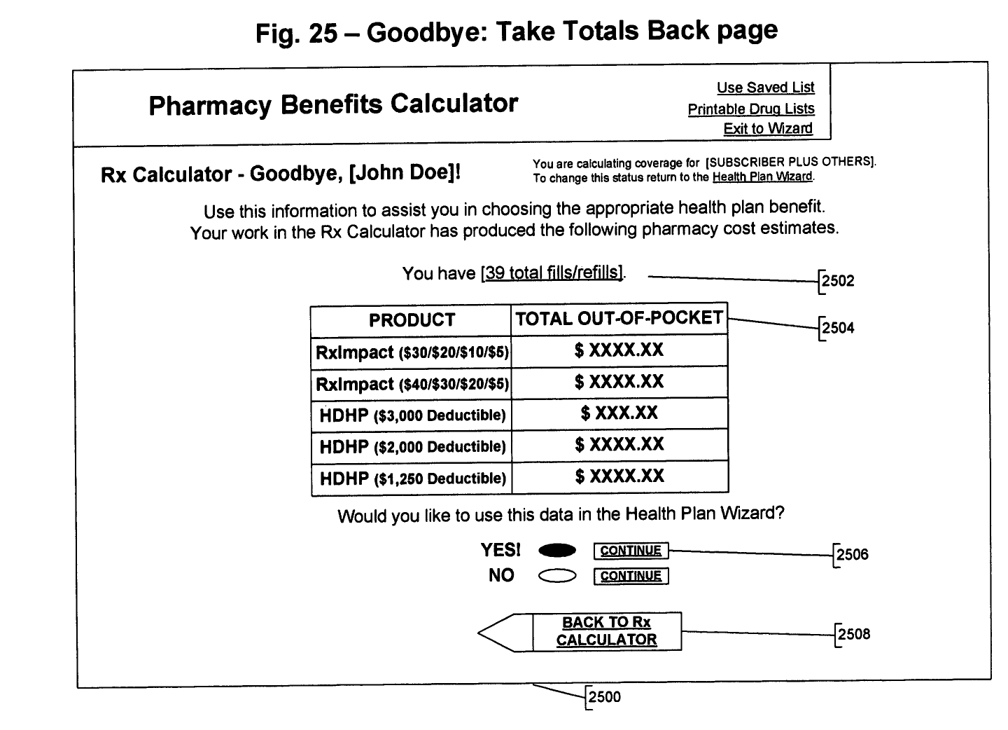

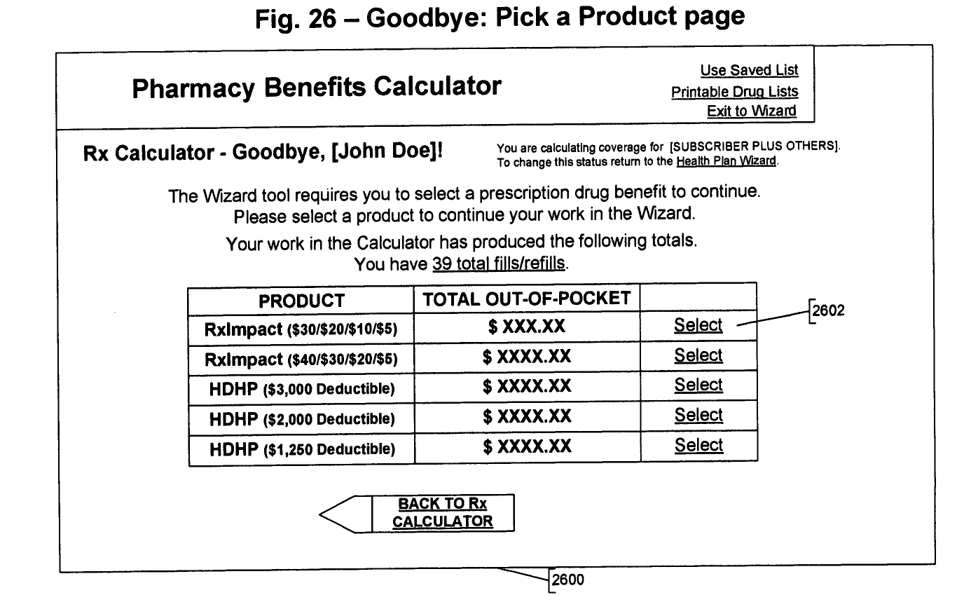

“Exit to Wizard” takes a user to a “Goodbye” page, FIG. 25 or 26. These pages then take the user back to a Health Plan Wizard or other web page that said user entered from.

The body of a page generally contains information that is useful to the user. The Welcome page, for example, comprises the name 404 of the user, a list 406 of people covered by the user's health care plan, a convenient redundant link 408 to exit the Pharmacy Benefits Calculator, and additional information 409 that explains the purpose and functioning of the Calculator.

The Welcome page 400 is the page user first sees when entering the Pharmacy Benefits Calculator. The user will have already provided adequate identification and security information so that they will be granted access to their personal confidential information, such as their claims history.

The name of the user and the persons covered by the user's health care plan are provided in the Welcome page, along with a convenient link back to the Health Plan Wizard so that the user may verify that he/she and said others are correctly identified. If there is a problem, the user may want to return to the Heath Plan Wizard to correct the problem.

The navigation buttons comprise a “Back” button 432 and a “Use the Pharmacy Benefits Calculator” button 434.

A “Back” button will generally take a user back to the page they were viewing prior to arriving at the page they are looking at. Back button 432, therefore, takes a user back to the Health Plan Wizard.

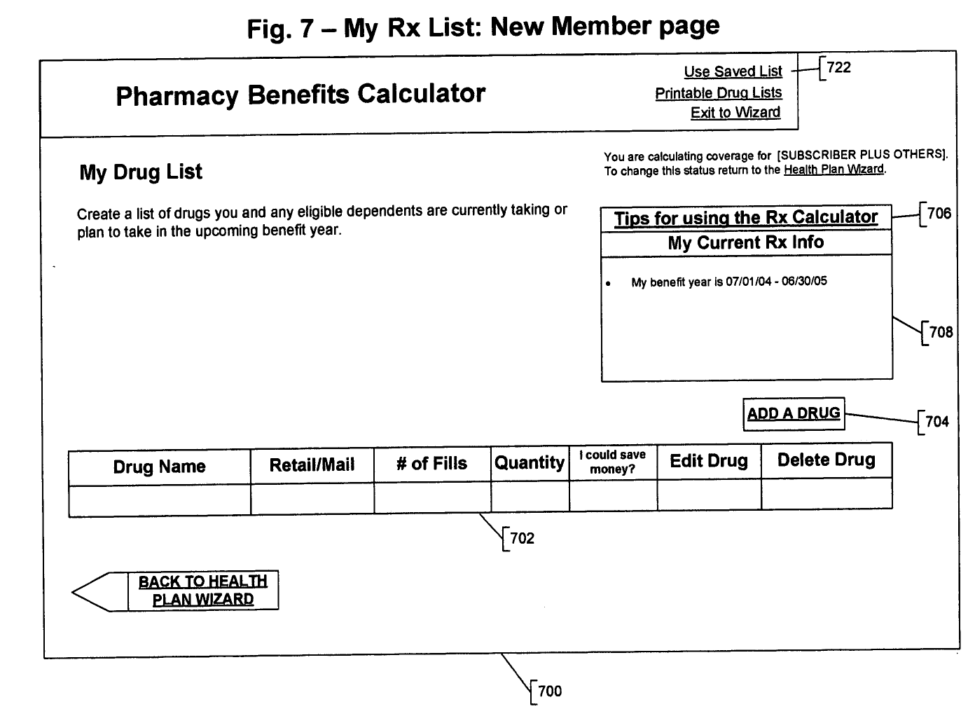

The “Use the Pharmacy Benefits Calculator” button takes the user to a “My Rx List” page. This might be one of FIGS. 7, 8, 9 or 10.

Prior to using the Pharmacy Benefits Calculator, a user may want to read in a saved list of drugs. They may do this by clicking on the “Used Saved List” link in a header of a given page. They will then be taken to an “Open My Saved List” page.

An “Open My Saved List” page 500 is illustrated in FIG. 5.

The body of an Open My Saved List page comprises a “My Saved List of Drugs” table. The My Saved List of Drugs table 502 comprises a first column 504 of the names of saved lists, a second column 506 of the dates the respective lists were saved on, and a third column 508 of “Select” hyperlinks.

If a user clicks on a Select hyperlink, then the appropriate drug list is read into the Pharmacy Benefits Calculator. Said drug list may be found on the operational data store database 122 (FIG. 2).

The user may then click on a “To My Rx List Page” button, 510 and be sent to an appropriate “My Rx List Page” (FIGS. 7 to 10).

Referring to FIG. 4, when a user is on a Welcome page, they may wish to view a list of common drugs available in a given health care plan. They can do this by clicking on the “Printable Drug List” hyperlink 424. They will then be taken to a “Printable Drug Lists” page.

A “Printable Drug Lists” page 600 is illustrated in FIG. 6.

The body of a Printable Drug Lists page comprises a “Printable Drug Lists Available for Enrollment” table 602. The Printable Drug Lists Available for Enrollment table comprises a first column 604 that lists the major categories of health plans available to the user, and a second column of 606 of “Select” hyperlinks.

If a user clicks on a Select hyperlink, then the appropriate list of drugs and their levels of coverage for the indicated major category of health plan is printed.

The user may then click on a “To My Rx List Page” button, 610 and be sent to an appropriate “My Rx List Page” (FIGS. 7 to 10).

FIG. 7 illustrates an “My Rx List: New Member” page 700 that a user would be directed to if they were a new member. A new member is a user for whom there are no previous pharmacy or medical claim records available to the Pharmacy Benefits Calculator. For example, a new member might be a new employee that has not been previously covered by the health insurance company offering the available health care plans.

The body of the My Rx List: New Member page comprises a “Tips for using the Rx Calculator” pop-up 706, a “My Current Rx Info” table 708, a “Drug List” table 702 and an “Add a Drug” hyperlink 704.

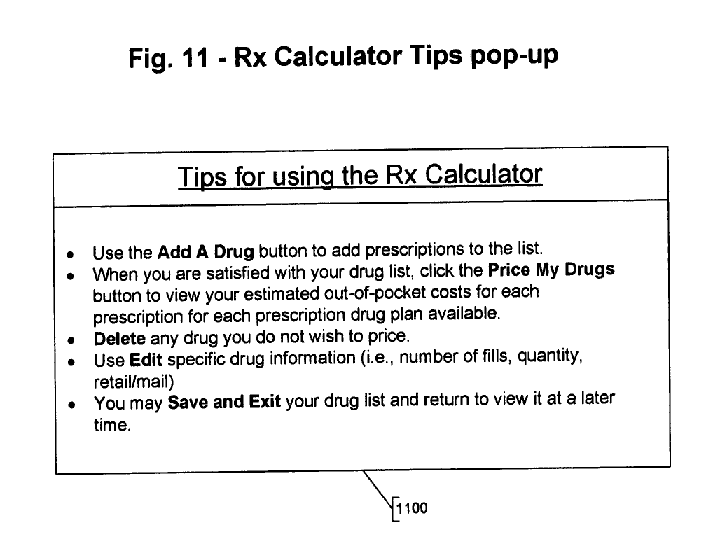

The “Tips for using the Rx Calculator” pop-up may be shaded a very noticeable color, such as bright yellow. This will act to direct the user's attention to it. If the user rolls over the pop-up, then the “Tips for using the Rx Calculator” pop-up 1100 (FIG. 11) will appear. This box gives directions for using the Rx Calculator.

The term “Rx Calculator” is a synonym for the term “Pharmacy Benefits Calculator” as used herein.

Referring back to FIG. 7, the “My Current Rx Info” table 708 has as single column. This column displays information about the user. In this case it shows the period that will be covered by the upcoming “Benefit Year”.

“Benefit Year” is a synonym for “plan year” as used herein.

The Drug List table 702 comprises the columns “Drug Name”, “Retail/Mail”, “# of Fills”, “Quantity”, “I could save money?”, “Edit Drug”, and “Delete Drug”.

The Drug Name column displays the name of a drug.

The Retail/Mail column displays whether or not the user fills a given drug via a retail pharmacy or a mail order pharmacy. The distinction of whether or not a drug is filled via a retail or mail order pharmacy is important since it affects the benefits level available for said drug. Drugs for chronic conditions that are taken continuously by a user are presumed filled on a monthly basis at a retail pharmacy. Drugs for chronic conditions are presumably filled on a three month basis with a mail order pharmacy. Hence benefit levels for a given script of drugs filled by a mail order pharmacy will tend to be three times the benefit levels for scripts of the same drugs filled at a retail pharmacy.

The # of Fills column indicates how often the scripts of a given drug are to be filled in a given plan year.

The Quantity column indicates how many units of a given script are in a given fill.

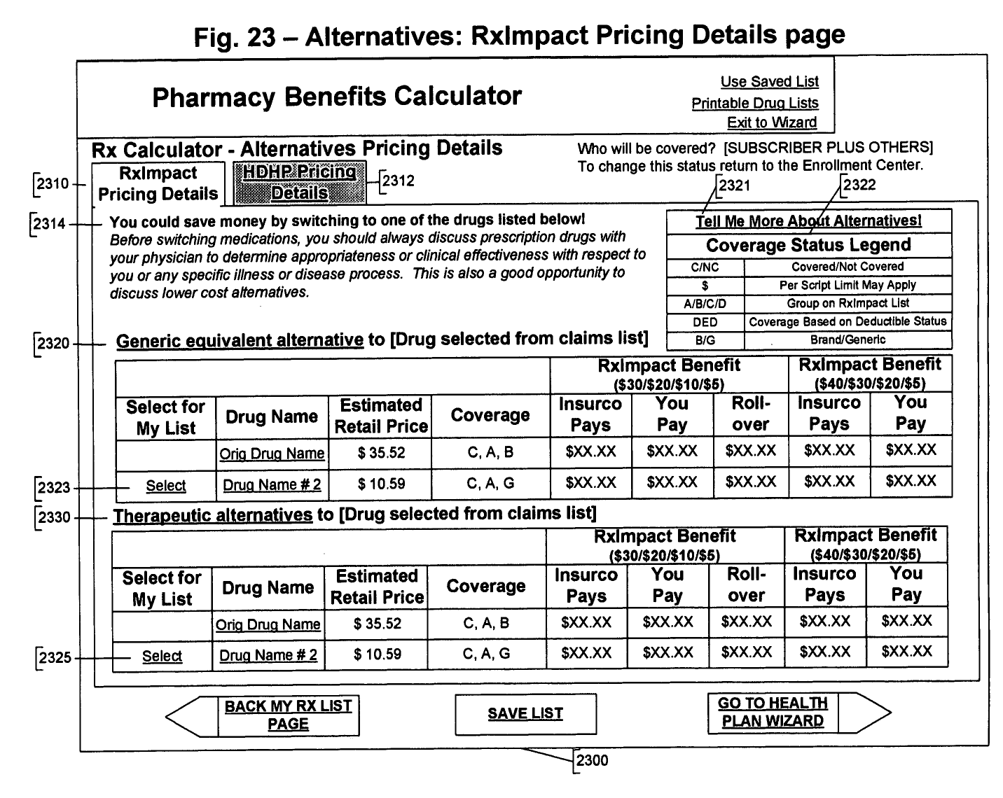

The “I could save money?” column provides hyperlinks to an “Alternatives:” page (FIG. 23). As described more fully below, an Alternatives: page provides a means for a user to see if lower cost alternatives are available for a given drug. Hyperlinks to the Alternatives Pricing page are provided only for drugs for which there are lower cost generic or therapeutic alternative available.

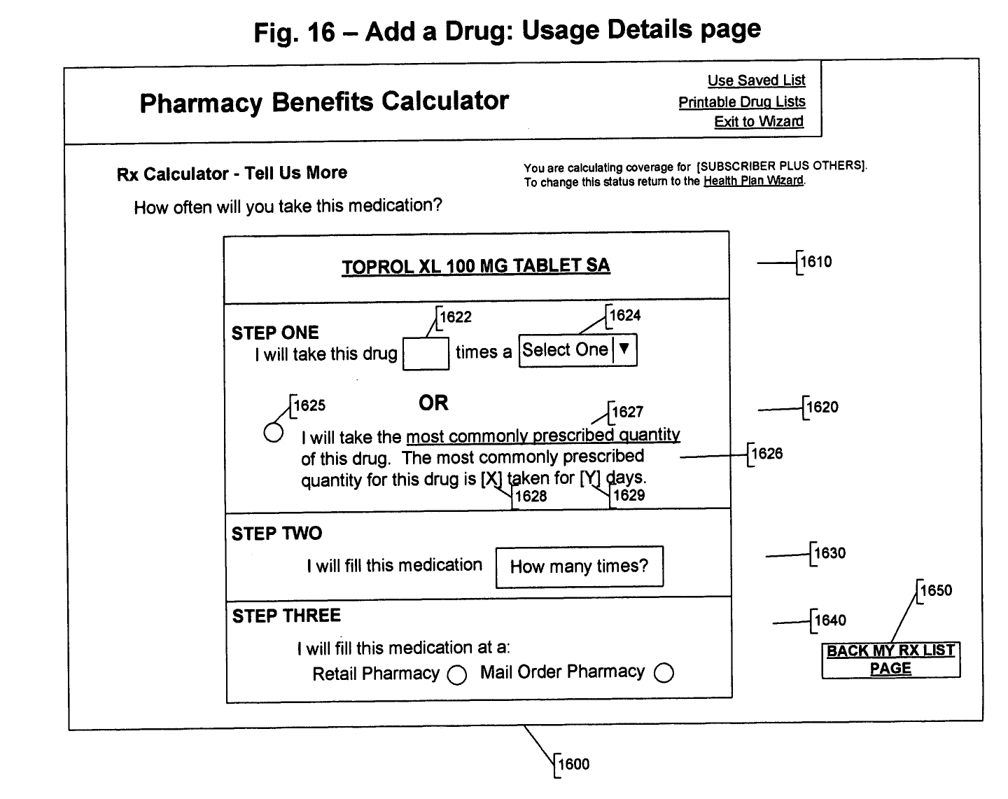

The Edit Drug column provides hyperlinks to an “Add a Drug: Usage Details” page (FIG. 16). As described more fully below, an Add a Drug: Usage Details page provides a means for a user to modify the data for the Retail/Mail, # of Fills, or Quantity column of the Drug List table 702.

The Delete Drug column provides hyperlinks which delete a given drug from the Drug List.

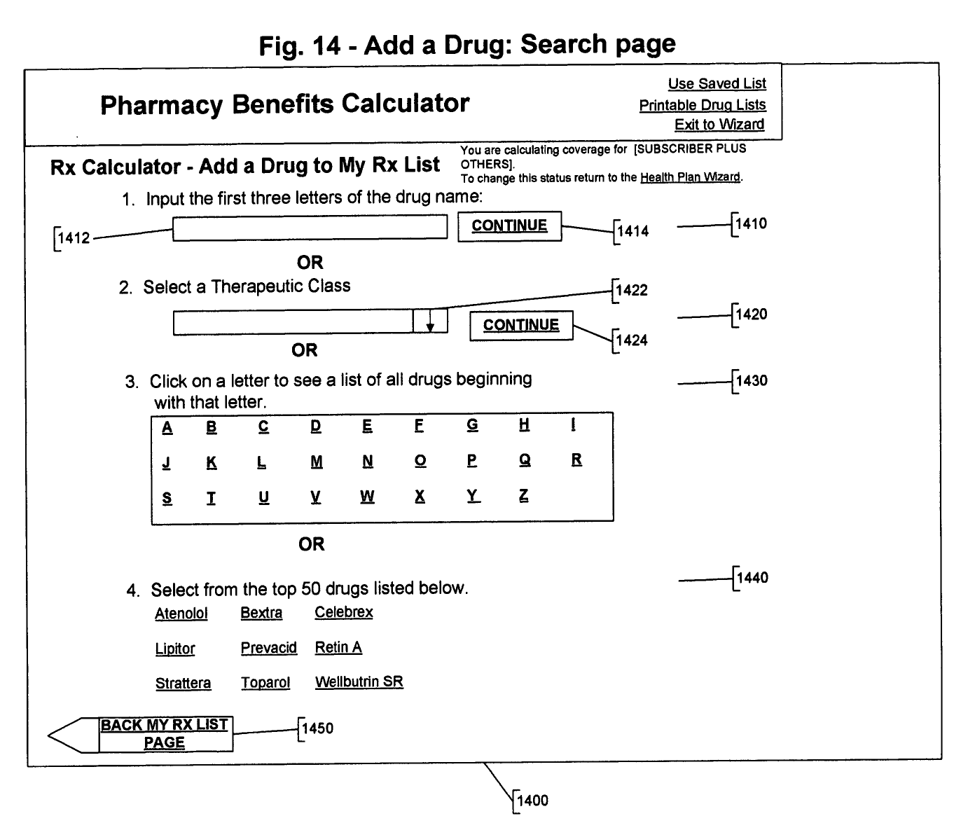

The “Add a Drug” hyperlink takes a user to an “Add a Drug: Search” page (FIG. 14). As described more fully below, an Add a Drug: Search page, provides means for a user to find a new drug to add to the Drug List table.

If a user is a new member, then there are no drugs in their Drug List. The user must then either add drugs using the Add a Drug hyperlink 704, or read in a saved drug list by clicking on the Use Saved List hyperlink 722. If the user had performed either of these functions prior to viewing the Rx List Page for new members, then the drugs previously added in or read in from a saved list would be displayed.

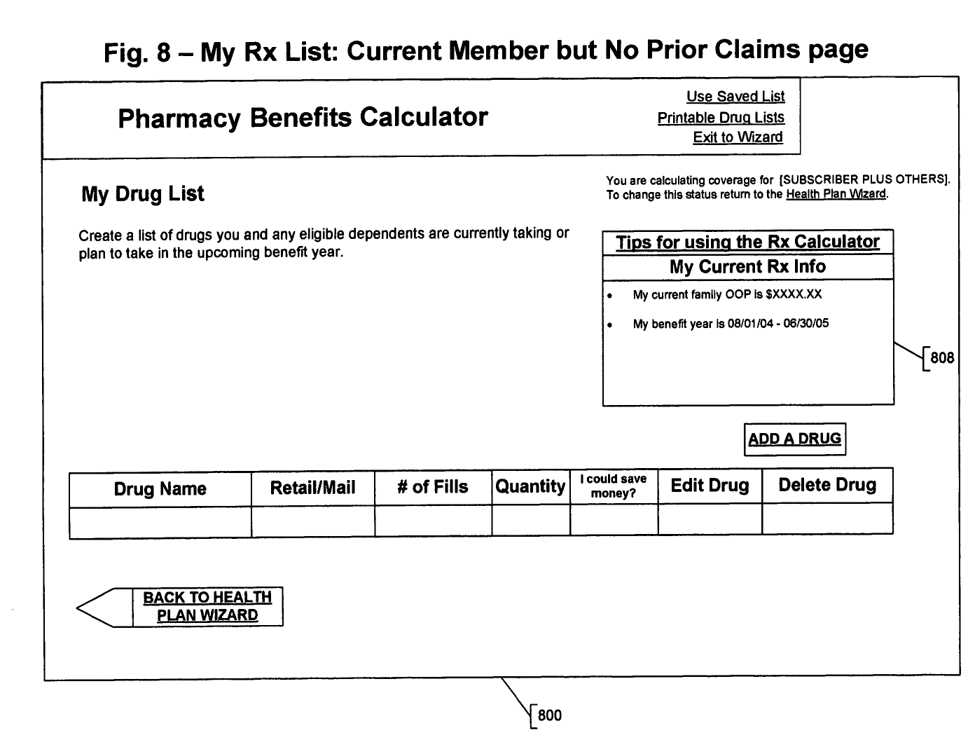

If a user is a current member but has no prior pharmacy claims, then the first time he/she goes to the My Rx List Page, they will be shown page 800 illustrated in FIG. 8. This is the same page as the new member page of FIG. 7, except the user's current family out-of-pocket expenses (OOP) is shown in the My Current Rx Info table 808.

If a user is a current member that has prior pharmacy claims, but does not have anyone else, such as family members or dependents, covered by their health care plan, then the first time they go to the My Rx List Page, they will be shown page 900 illustrated in FIG. 9. This displays additional information and has a number of additional features relative to the My Rx List Page illustrated in FIG. 8 for current members with no claims.

The Drug List table 902 shows the drugs that have been used by the user for the past plan year. The user would be able to see, for example, that Drug Name #1 was obtained at a retail pharmacy, that there were 12 fills in the past year, that there were 30 units of the drug per fill, and that were lower cost alternatives to Drug Name #1.

If the user anticipates that their drug needs will change in the upcoming plan year, then said user may click on the appropriate Edit, Add a Drug, or Delete hyperlinks.

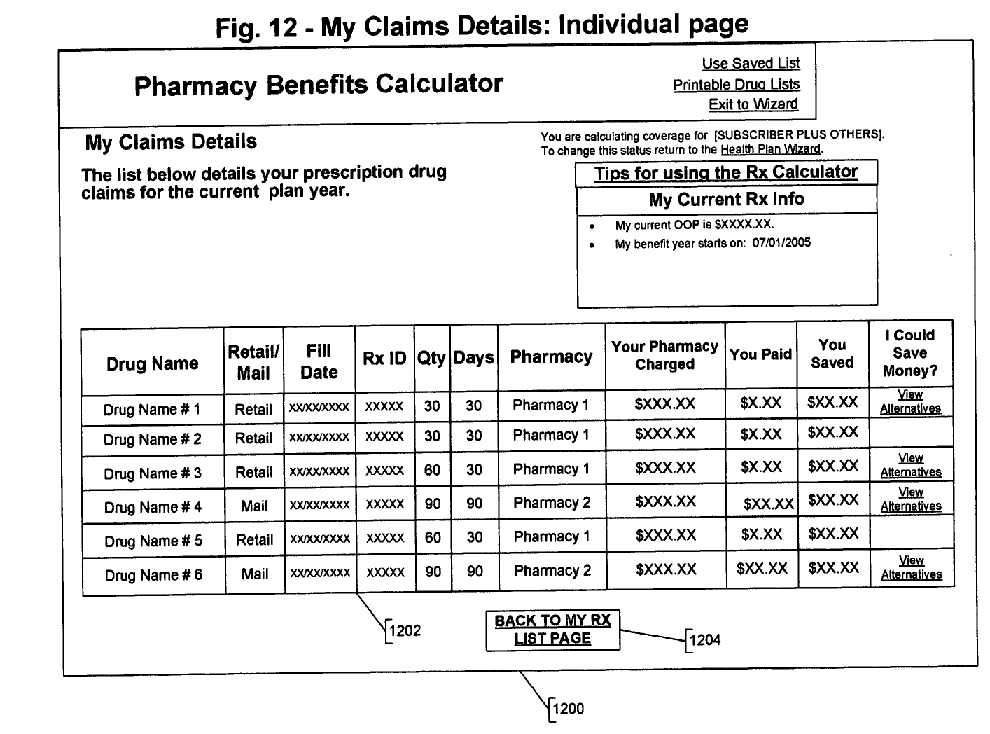

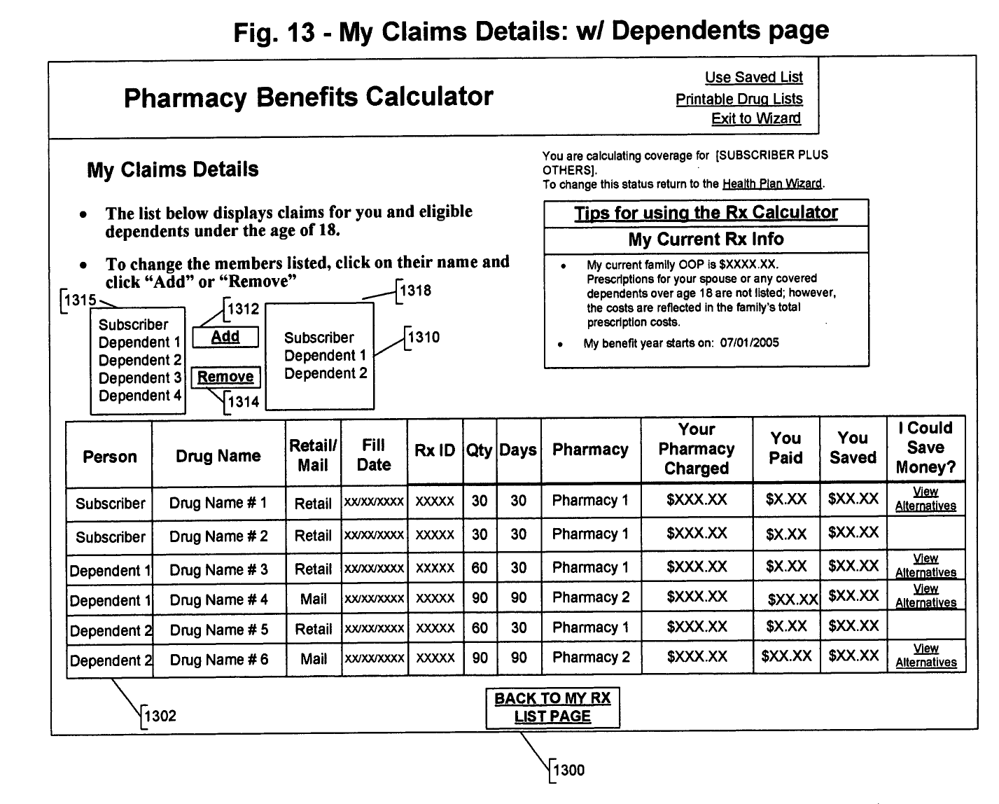

If the user wants to get more details about their claims, they may click on a “Claims detail” hyperlink 904. The user will then be taken to a “My Claims Detail” page. My Claims Detail pages are illustrated in FIGS. 12 and 13 and are described in more detail below.

If the user wants to see what the lower cost alternatives might be for a given drug, they can click on a “View Alternatives” hyperlink 906. The user will then be taken to a “Alternatives Pricing” page. An Alternatives Pricing page is illustrated in FIG. 23 and is described in more detail below.

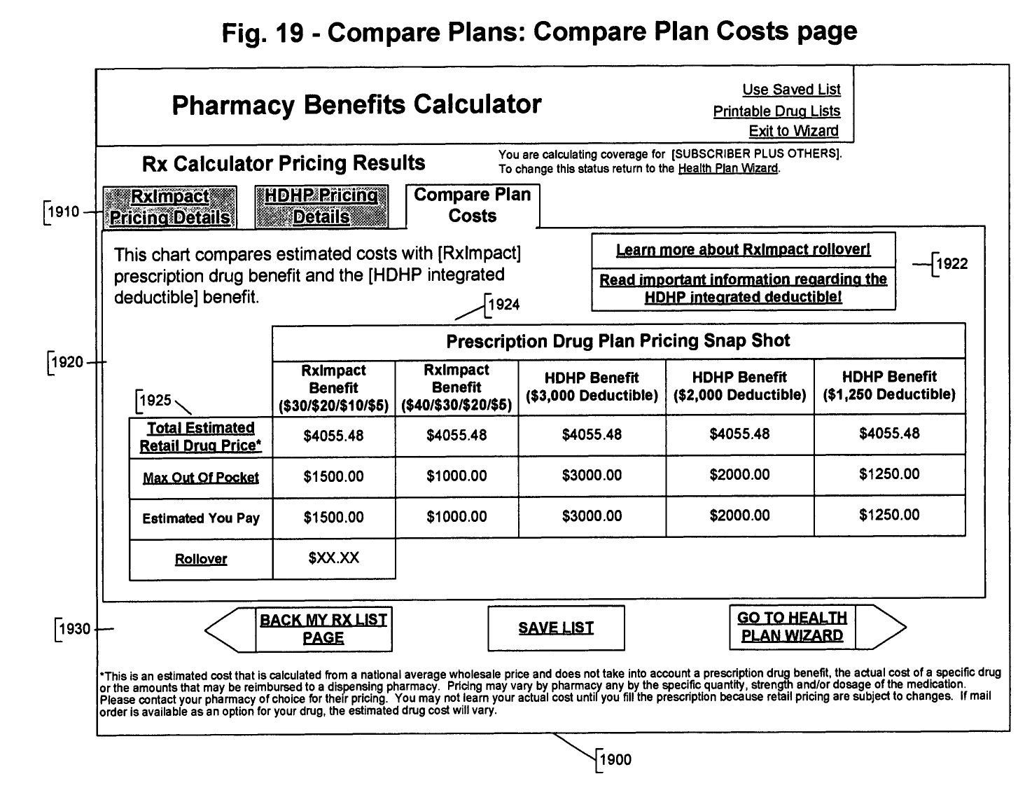

If a user wants to see what their out-of-pocket costs are going to be for their drugs, they can click on a “Price My Drugs” hyperlink 908. When a user clicks on a “Price My Drugs” hyperlink, they are taken to a “Compare Plans” page. A Compare Plans page is illustrated in FIGS. 19, 21 and 22 and are more fully described below.

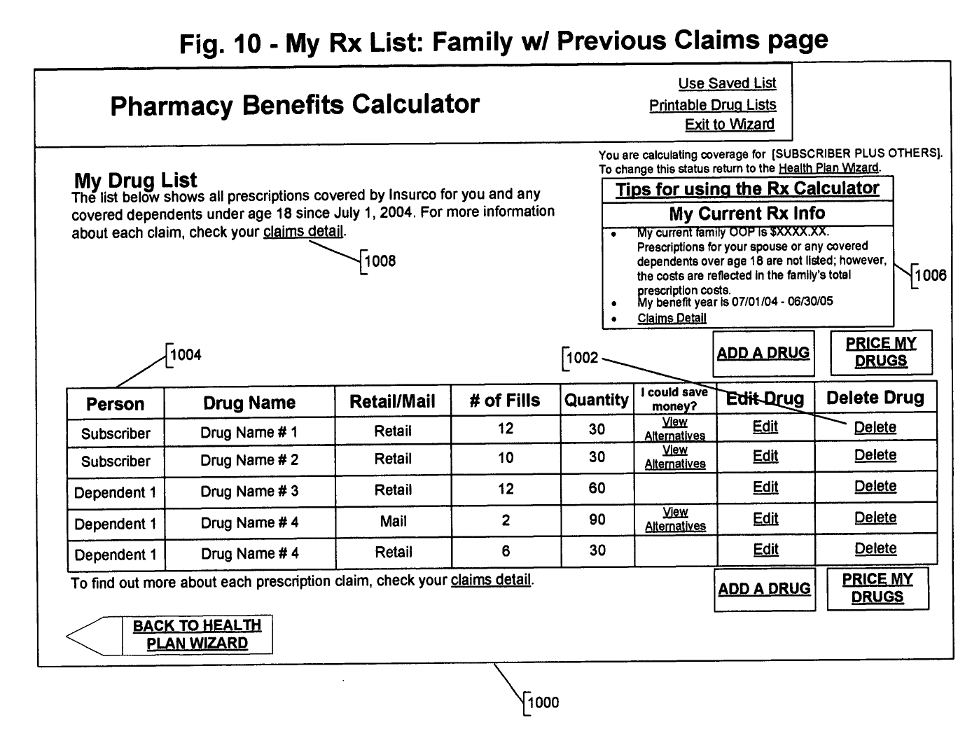

If a user is a current member that has prior pharmacy claims and has others, such as family members or dependents, covered by their health care plan, then the first time they go to the My Rx List Page, they will be shown page 1000 illustrated in FIG. 10. This displays additional information to the My Rx List Page illustrated in FIG. 9 for current members with claims but no others covered by their health care plan.

The Drug List table now comprises an additional “Person” column 1004. The person column displays the person that used a given drug. Under United States law as of May 2004, a health insurance company cannot provide personal pharmacy usage information of a given person to another family member if said person is over the age of 18. Hence for embodiments of the present invention that are used by residents of the United States, the drug information for family members over the age of 18 is not shown.

The My Current Rx Info table 1106, however, may show the total out-of-pocket expenses for a user. It also provides an explanatory note regarding the fact that the drugs purchased by persons over the age of 18 and spouses are not shown.

Other jurisdictions may have other laws and rules governing what information may be displayed.

When a user clicks on a Claims Detail hyperlink (e.g. item 1008), they are taken to a “My Claims Details” page.

A My Claims Detail page 1200 is illustrated in FIG. 12. Said My Claims Detail page is suitable for an individual.

The body of My Claims Detail page 1200 comprises a Claims Detail table 1202. Said Claims Detail Table comprises information regarding each individual pharmacy claim made by the user over the past plan year. The columns comprise the name of a drug (Drug Name), whether or not a prescription was filled at a retail pharmacy or mail order pharmacy (Retail/Mail), the date a given prescription was filled (Fill Date), an ID number for the script (Rx ID), the number of doses (Qty), the number of days supply (Days), the name of the pharmacy that filled the prescription (Pharmacy), the actual retail price of the script (Your Pharmacy Charges), the out-of-pocket expenses for the user (You Paid), the amount that was covered by said user's health care plan (You Saved) and a link to an Alternatives Pricing Page (e.g. item 2300, FIG. 23) if lower cost alternatives are available for a given script.

A “Back to My Rx List Page” hyperlink 1204 is provided to allow a user to return to the appropriate My Rx List page.

If a user has others covered by their health care plan, then they will be directed to a My Claims Detail: w/ Dependents page after they click on a Claims Detail hyperlink.

A My Claims Detail: w/ Dependents page 1300 is illustrated in FIG. 13. This is similar to the claims Detail page for an individual (FIG. 12). It displays 1302 the additional information of the person to whom a prescription was prescribed, assuming that providing said information is legal or not otherwise prohibited.

A means 1310 is also provided for displaying the pharmacy claims of a subset of the persons covered by said user's health care plan. Appropriate names in a list 1315 of all persons covered by the user's health care plan are clicked on and then the Add 1312 or Remove 1314 buttons are selected to add or remove names from the display list 1318.

Referring back to FIG. 7, if a user wishes to add a drug to their Drug List 702, they click on a Add a Drug hyperlink 704. They are then taken to an UAdd a Drug Search” page.

FIG. 14 is an illustration of an Add a Drug Search page 1400.

The Add a Drug: Search page comprises several alternate means 1410, 1420, 1430, and 1440 and for providing a short list of candidate drugs to add to a Drug List. Providing said several alternate means has the surprising benefit of allowing a diverse group of users to effectively specify a drug of interest even if they only have partial information about which drug they want.

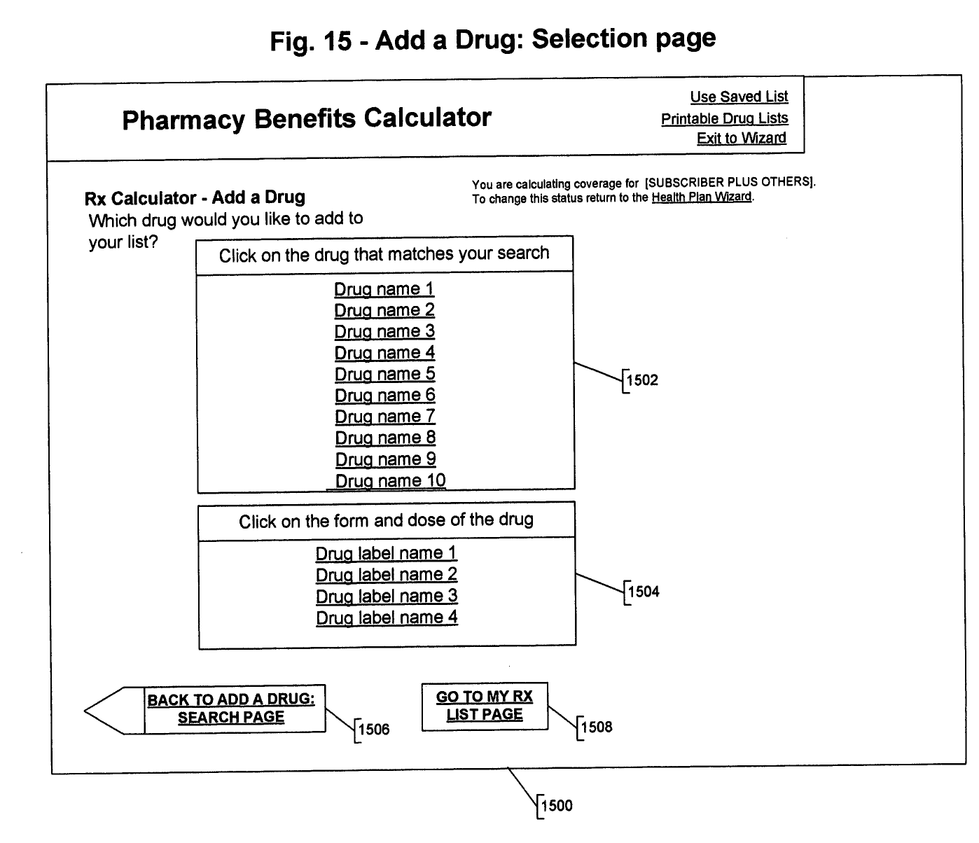

If a user knows at least part of the name of a drug, they may use means 1410 to enter said partial name. Means 1410 comprises a field 1412 for entering in a partial name of a drug. Said partial name may be the first three letters or more of the drug name. Upon entering said partial name, the user clicks the associated “Continue” hyperlink 1414. The user is then directed to an “Add a Drug Selection” page (item 1500, FIG. 15) where drugs with the same partial name are displayed. The user may then recognize the full name of the drug and select said drug. The Add a Drug: Selection page will be more fully described below.

If a user knows the therapeutic class of a desired drug, they may use means 1420 to enter said therapeutic class. A list of said therapeutic classes are provided as a drop down menu 1422. The user then selects a therapeutic class of interest and clicks on the associated Continue hyperlink 1424. The user is then directed to an “Add a Drug Selection” page where drugs within the same therapeutic class are displayed. The user may then recognize the full name of the drug they want and select said drug.

It has been discovered that said therapeutic classes are surprisingly useful to a large fraction of a diverse group of users if the names of the classes are common names and if the number of classes is in the range of 10 to 100. The number of classes is more preferably in the range of 20 to 50. A suitable list of therapeutic classes for English speaking people is found in Table 1 below.

TABLE 1

| Therapeutic Class | Therapeutic Class |
|---|---|
| Name | Description |
| Anti-infectives | Drugs in this class may be used to treat such conditions as HIV/AIDS, |
| | hepatitis, fungal infections, influenza, and herpes. This class can include |
| | drugs like antivirals and antifungals. |
| Antibiotics | Drugs in this class may be used to treat such conditions as bacterial |
| | infections, strep throat, and pneumonia. This class can include drugs like |
| | pencillins, tetracyclines, quinolones and sulfas. |
| Anticonvulsants | Drugs in this class may be used to treat such conditions as seizures, |
| | neuropathic pain. This class can include drugs like Depakote, Dilantin, |
| | and Neurontin. |
| Asthma | Drugs in this class may be used to treat such conditions as asthma and |
| | COPD. This class can include drugs like rescue inhalers, steroid inhalers, |
| | and theophyline. |
| Blood Agents | Drugs in this class may be used to treat such conditions as hemophilia, |
| | bleeding disorders, and anemia. This class can include drugs like Procrit |
| | and clotting factors. |
| Blood Thinners | Drugs in this class may be used to treat such conditions as blood clotting |
| | disorders. This class can include drugs like warfarin and heparins. |
| Chemotherapy | Drugs in this class may be used to treat such conditions as cancer, |
| | leukemia, and lymphoma. |
| Cholesterol | Drugs in this class may be used to treat high cholesterol. This class can |
| | include drugs like statins and niacin. |
| Contraceptives | Drugs in this class may be used for birth control. |
| Cough/Cold/Allergy | This class can include drugs like cough suppressants, antihistamines, |
| | nasal steroids, and expectorants. |
| Dermatology - Acne | Drugs in this class may be used to treat such conditions as acne. |
| Dermatology - Other | Drugs in this class may be used to treat such conditions as hemorrhoids, |
| | psoriasis, wound care, skin rash, and itching. This class can include |
| | drugs like ointments and cream for skin conditions. |
| Diabetes | Drugs in this class may be used to treat diabetes. This class can include |
| | drugs like insulin and oral medications for diabetes. |
| Diabetic Supplies | Products in this class may be used to monitor blood glucose and inject |
| | insulin in diabetics. This class can include devices like blood glucose |
| | meters and strips, lancets, insulin syringes and needles. |
| Eye/Ear/Mouth/Throat | Drugs in this class may be used to treat such conditions as dry eyes, |
| | glaucoma, and external ear infections. This class can include drugs like |
| | throat lozenges, ear drops, eye drops, and saliva stimulants. |
| Fertility | Drugs in this class may be used to treat infertility. This class can include |
| | drugs like ovulation stimulants and fertility regulators. |
| Genitourinary | Drugs in this class may be used to treat such conditions as bladder |
| | spasms, enlarged prostate, and vaginal irritation. |
| Growth Hormone | Drugs in this class may be used to treat such conditions as short stature, |
| | growth failure, and AIDS wasting. |
| Heart | Drugs in this class may be used to treat conditions like high blood |
| | pressure, congestive heart failure, angina, and arrhythmia's. This class |
| | includes such items as beta-blockers, diuretics, and ace inhibitors. |
| Impotence | Drugs in this class may be used to treat erectile dysfunction. |
| Mental Health - Anxiety | Drugs in this class may be used to treat such conditions as anxiety. This |
| | class can include drugs like benzodiazepines. |
| Mental Health - Depression | Drugs in this class may be used to treat such conditions as depression, |
| | mood disorders. This class can include drugs like SSRIs and tricyclics. |
| Mental Health - Misc. | Drugs in this class may be used to treat such conditions as sleeping |
| | disorders, dementia, and psychoses. This class can include drugs for |
| | insomnia and antipsychotics. |
| Mental Health - Stimulants | Drugs in this class may be used to treat such conditions as attention |
| | deficit disorder, narcolepsy, and obesity. This class can include drugs like |
| | amphetamines and anorexiants. |
| Misc - Biologicals | No explanation available for this at this time |
| Misc - Endocrine | Drugs in this class may be used to treat such conditions as pituitary |
| | irregularities and cervical ripening. This class can include drugs like |
| | prostaglandins and corticotropin. |
| Misc - Neurology | Drugs in this class may be used to treat such conditions as Parkinson's |
| | disease, myasthenia. This class can include drugs like Sinemet. Mirapex, |
| | and Requip. |
| Misc - Respiratory | Drugs in this class may be used to treat such conditions as cystic fibrosis. |
| | This class can include drugs like respiratory inhalants. |
| Multiple Schelrosis | This class can include drugs like Avonex, Betaseron, and Copaxone. |
| Muscle/Bone | Drugs in this class may be used to treat such conditions as muscle |
| | spasms. This class can include drugs like muscle relaxants. |
| Nutritional/Vitamins | Drugs in this class may be used to treat such conditions as vitamin |
| | deficiencies. This class can include prenatal vitamins. |
| Ostoperosis Drugs | Drugs in this class may be used to treat such conditions as brittle bones. |
| | This class can include drugs like calcium controllers and estrogen |
| | modulators. |
| Pain Mgmt - Cox 2 | Drugs in this class may be used to treat such conditions as pain. This |
| | class can include drugs like Cox-II inhibitors-Celebrex, Bextra, etc. |
| Pain Mgmt - Migraines | Drugs in this class may be used to treat such conditions as migraines. |
| | This class can include “Triptan” drugs like Imitrex. |
| Pain Mgmt - Narcotic | Drugs in this class may be used to treat such conditions as pain. This |
| | class can include drugs like codeine and hydrocodone. |
| Pain Mgmt - Non-Narcotic | Drugs in this class may be used to treat such conditions as pain. This |
| | class can include non-steroidal anti-inflammatory drugs (NSAIDs) like |
| | ibuprofen and naproxen. |
| Products/Supplies | This class can include items like miscellaneous needles/syringes. |
| Steriods | This class can include drugs like prednisone and anabolic steroids. |
| Stomach - H2 | Drugs in this class may be used to treat such conditions as ulcers, acid |
| | reflux, indigestion. This class can include drugs like H2 blockers--Zantac, |
| | Tagamet, etc. |
| Stomach - PPI | Drugs in this class may be used to treat such conditions as ulcers, acid |
| | reflux, indigestion. This class can include drugs like Proton Pump |
| | Inhibitors--Prilosec, Nexium, etc. |
| Stomach Gastro | Drugs in this class may be used to treat such conditions as constipation, |
| | diarrhea, ulcers, indigestion, nausea, and irritable bowel syndrome. This |
| | class can include drugs like laxatives, antidiarrheals, antacids, and |
| | antinauseants. |
| Thyroid | Drugs in this class may be used to treat such conditions as hyperthryoid |
| | and hypothryoid. |

A person of ordinary skill in the art may automatically assign a large number of drugs to the different therapeutic classes of Table 1 using formal hierarchical therapeutic classification schemes. The assignment of formal hierarchical therapeutic classification schemes to a list of drugs is provided by certain pharmacy data companies, such as First DataBank of San Bruno Calif., Medi-Span of Indianapolis, Ind. and U.S. Pharmacopeia of Rockville, Md.

Similar therapeutic classifications may be made in a different language using terminology recognizable to a diverse group of users speaking said language.

Table 1 or a similar table providing greater explanation of the meaning of the name of each therapeutic class may be provided in a Pharmacy Benefits Calculator.

If a user knows the first letter of a desired drug, they may use means 1430 to enter said first letter. Upon selecting a letter, the user is then directed to an “Add a Drug: Selection” page where drugs with in the same first letter are displayed. The user may then recognize the full name of the drug they want and select said drug.

If a user thinks they might remember the name of a desired drug if they saw it, they may use means 1440 to see said name. Means 1440 provides a list of the top 50 drugs prescribed for a given population of users. A user may readily scan said list to see if they recognize the name of their desired drug. Each name is a hyperlink. If the user recognizes the name of the drug, then they may click on said name. Upon clicking on said name, the user is then directed to an “Add a Drug Selection” page where drugs with said name are displayed. The user may then recognize the full name of the drug they want and select said drug.

A “Back to My Rx List Page” hyperlink 1450 may be provided to allow the user to return to their Rx List page.

An Add a Drug: Selection page 1500 is illustrated in FIG. 15.

The body of the Add a Drug Selection page comprises a “Click on the drug that matches your search” table 1502 and a “Click on the form and dose of the drug” table 1504. When a user first enters the Add a Drug: Selection page, only the “Click on the drug that matches your search” table appears.

The “Click on the drug that matches your search” table shows a list of drugs that match the initial criteria specified by the user in the “Add a Drug: Search” page. For example, if the user had selected a given therapeutic class, then the drugs in that therapeutic class would be listed.

Each drug name (e.g. “Drug name 1”) in table 1502 is a hyperlink. If the user recognizes the drug they are looking for in the table, they click on the appropriate link and the “Click on the form and dose of the drug” table 1504 appears.

The “Click on the form and dose of the drug” table shows the different drug label names available for the given drug name selected from table 1502.

A drug label name comprises the name of the drug, the dose, the form, and other identifying information about a particular embodiment of a drug. For example, the drug label name “Toprol XL 100 MG Tablet SA” applies to the drug Toprol XL when it is provided in 100 mg tablet form.

Each drug label name in table 1504 is a hyperlink. If the user selects a drug label name of interest and clicks on it, he/she is taken to a “Add a Drug: Usage Details” page (e.g. FIG. 16). An Add a Drug: Usage Details page is described more fully below.

If the user does not see a drug of interest in table 1502, they may click on the “Back to Add a Drug: Search Page” hyperlink 1506. This will return them to the Add a Drug: Search page where they may try a different initial criteria.

The user may alternatively click on a “Go to My Rx List Page” hyperlink 1508 to return to the appropriate “My Rx List” page.

Once a user has selected a given drug label name on the Add a Drug: Selection page, they are taken to an Add a Drug: Usage Details page.

An Add a Drug: Usage Details page 1600 is illustrated in FIG. 16. The Add a Drug: Usage Details page comprises four boxes 1610, 1620, 1630 and 1640. The boxes present and request information to adequately specify the script of interest such that the Pharmacy Benefits Calculator can estimate the price per script and quantity of the script that the user anticipates taking in the next plan year.

Box 1610 displays the label name of the drug the user specified in the Add a Drug: Selection page. The example shown in FIG. 16 is the label name “TOPROL XL 100 MG TABLET SA”. The label name is a hyperlink. Upon clicking on the hyperlink, the user will be presented with more detailed information about that particular drug.

The “Step One” box 1620 requests the user to input either the number of times they will take the drug 1622 in a given period of time 1624, or whether or not they will take the most commonly prescribed quantity of the drug.

The period of time is selected from a drop down menu which may show common time periods of “day”, “week” or “month”.

To select the most commonly prescribed quantity, the user clicks on button 1625.

A “most commonly prescribed quantity” hyperlink 1627 is provided to display more explanation of what the term “most commonly prescribed quantity” means.

Dynamic fields [X]1628 and [Y] 1629 are provided to show the user what the most commonly prescribed quantities are for the given drug label name.

The most commonly prescribed quantity may be determined from the overall records available for the pharmacy claims of a given set of users.

The “Step Two” box 1630 requests that the user input how many times he/she user will fill the medication in a given plan year.

The “Step Three” box 1640 requests that the user specify whether or not the drug will be obtained from a retail pharmacy or a mail order pharmacy. The Step Three box is only shown for drugs that are prescribed for chronic conditions, such as blood pressure medications.

Upon filling in the necessary information, the user may then return to the appropriate My Rx List page by clicking on the Go To My Rx List hyperlink 1650.

The user is then taken to a “My Rx List: w/ Added Drugs” page.

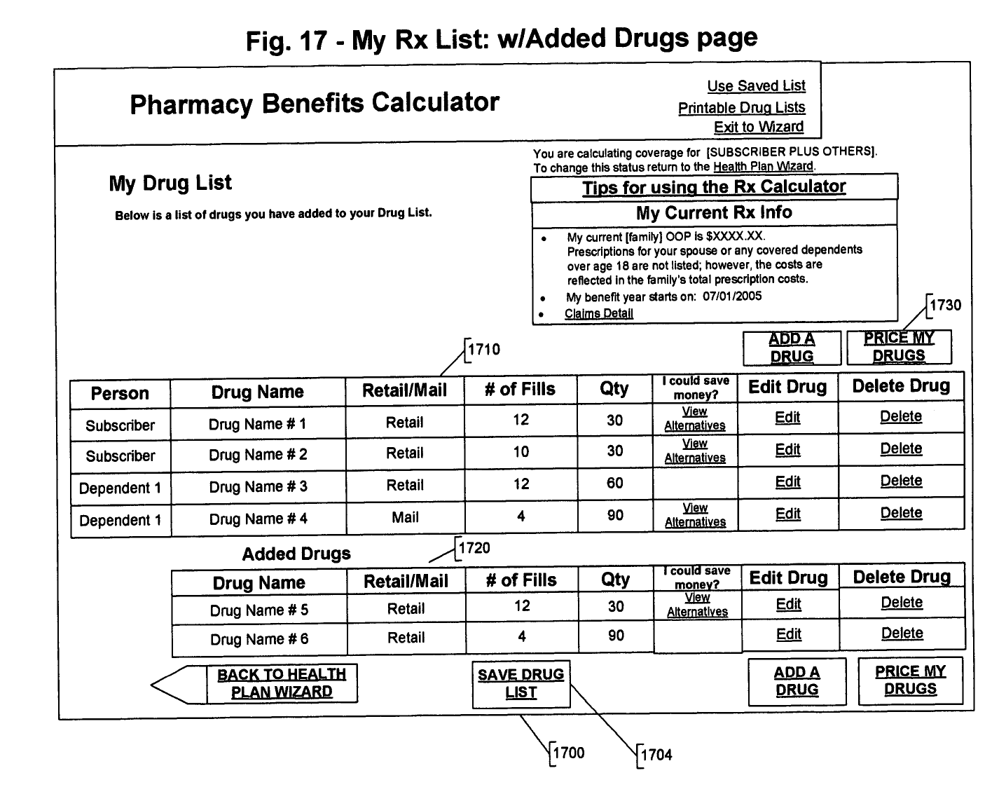

FIG. 17 illustrates a My Rx List: w/ Added Drugs page 1700. The body of the page comprises the original Drug List table 1710 and an “Added Drugs” table 1720.

The user may then click on a “Save Drug List” hyperlink 1704 to save the new list with the added drugs. They are then taken to a “Save My List” page.

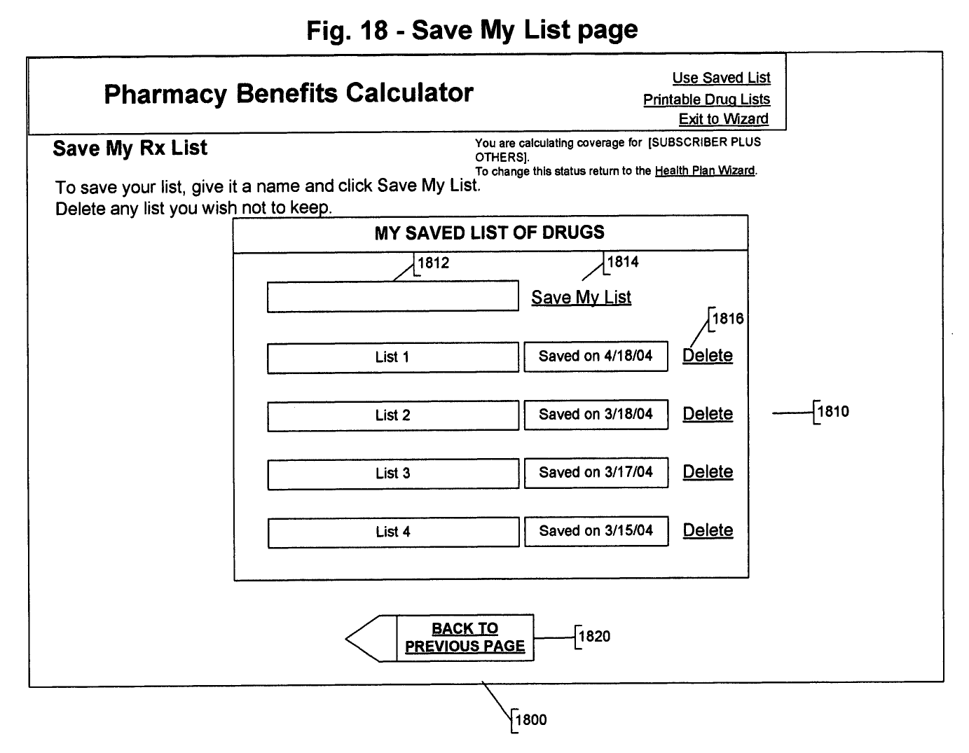

A “Save My List” page 1800 is illustrated in FIG. 18.

The body of a Save My List page comprises a “My Saved List of Drugs” table 1810.

The first row of the My Saved List of Drugs table 1810 has an input box 1812 where the user can type in the name of their current Drug List. After typing in the name, user may click on the Save My List hyperlink 1814 to save the list. The list is then time stamped and displayed in one of the subsequent rows.

Prior saved lists are displayed below the first row of table 1810. Each list name has a “Delete” hyperlink 1816 that the user can click to remove a given list.

After the user has saved or deleted the lists he/she wishes to save, he/she may click the “Back to Previous Page” button 1820 to return to the page they entered from.

Referring back to FIG. 17, once a user is satisfied with their Drug List, they can then see how much their drug list will cost under the various health care plans available to them. Said user may do this by clicking on a “Price My Drugs” hyperlink 1730. This takes them to a “Compare Plans: Compare Plan Costs” page.

A Compare Plans: Compare Plan Costs page 1900 is illustrated in FIG. 19.

The body of a Compare Plans page comprises folder tabs 1910, folder pages 1920, and hyperlinks 1930. FIG. 19 shows a Compare Plans page with the Compare Plan Costs hyperlink activated and the Compare Plan Costs folder page visible.

The Compare Plan Costs folder page comprises pop-ups 1922 and a “Prescription Drug Plan Pricing Snap Shot” table 1924.

The Prescription Drug Plan Pricing Snap Shot shows the costs of the user's Drug List under the different health care plans available to the user. In this example, the user has two “Rxlmpact” plans available to them and three “HDHP” plans available to them.

Rxlmpact plans provide a fixed allowance for a given script depending upon the Group that said script is categorized into. The plan covers expenses up to the allowance. The user is responsible for any additional expense.

The two Rxlmpact plans illustrated in FIG. 19 each have four Groups. The allowance levels for the four Groups are shown in parenthesis (e.g. $30/$20/$10/$5).

The first Rxlmpact plan, “Rxlmpact Benefit ($30/$20/$10/$5)” has relatively low allowances, but allows the user to accumulate any credits for the unused portion of an allowance for a given script and roll that accumulated credit over from one plan year to the next.

The second Rxlmpact plan “Rxlmpact Benefit ($40/$30/$20/$5)” has relatively high allowances, but the user may not roll over accumulated credits.

Rxlmpact plans are more fully described in copending US patent application [FILL IN LATER], filed on [FILL IN FILING DATE] and entitled “Pharmacy Benefits Design”. Said application has been earlier incorporated by reference. HDHP plans are high deductible health plans. In these plans, the user pays the full cost of an initial deductible, such as $3,000. Prescription costs are included in the deductible. Additional health expenses, however, are 100% covered. A user may “buy down” their deductible by paying a higher premium.

The Prescription Drug Plan Pridng Snap Shot table shows rows providing the “Total Estimated Retail Drug Price”, the “Max Out of Pocket” costs, the “Estimated You Pay”, and if appropriate “Rollover” costs of the user's Drug List under the different health care plans. Several of the row names are hyperlinks which provide pop-ups of additional explanatory information.

The columns of table 1924 may have different background shades depending upon which type of plan the column corresponds to. This color shading may be preserved on other pages of the Pharmacy Benefits Calculator where the information presented corresponds to a given type of health plan.

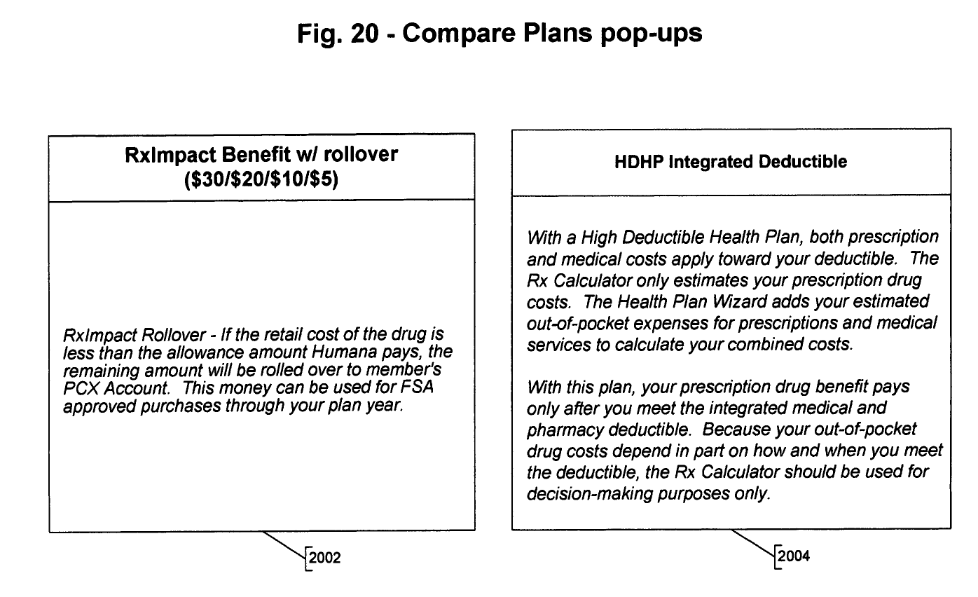

If a user wishes to get more information about a given type of health plan, they can click on the pop-ups 1922. The text 2002 and 2004 of said pop-ups is shown in FIG. 20.

If a user wishes to see more details on the pricing of their Drug List under a given type of health plan, they can click on one of the folder tabs 1910. If they click on the “Rx Impact Pricing Details” tab they will be taken to the “Compare Plans: Rxlmpact Pricing Details” page.

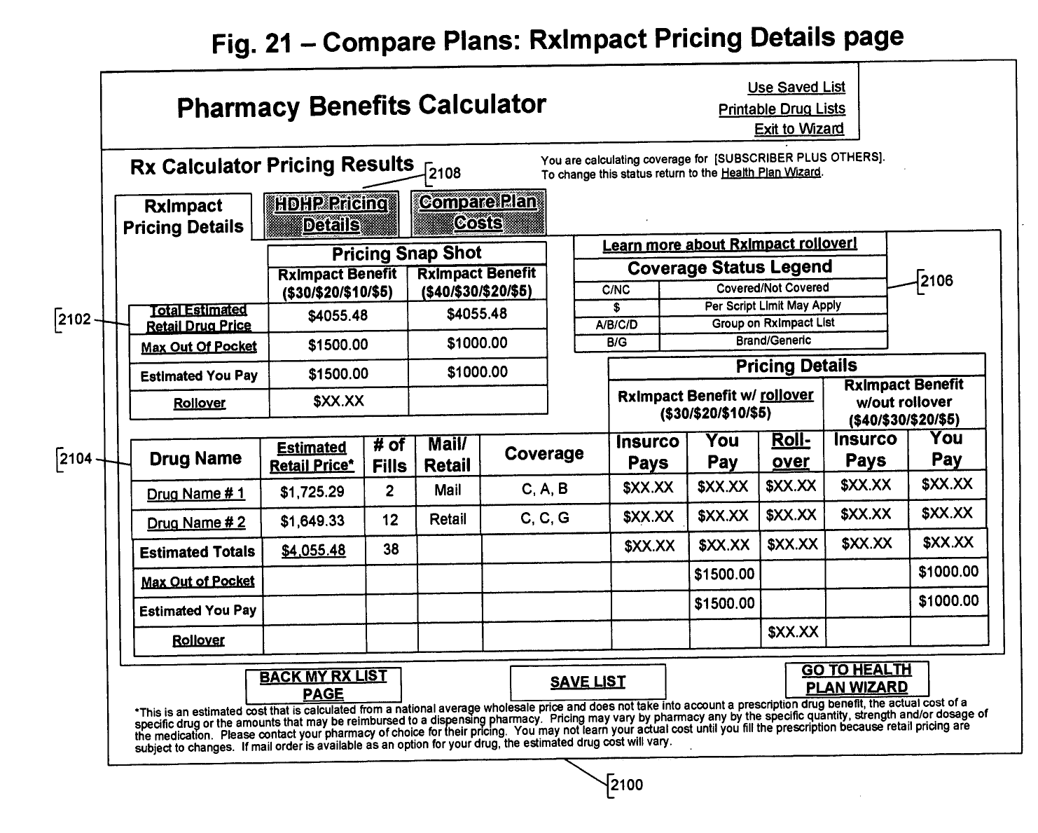

FIG. 21 illustrates the Compare Plans: Rxlmpact Pricing Details page 2100.

The Rxlmpact Pricing Details folder page of this page comprises a “Pricing Snap Shot” table 2102, “Pricing Details” table 2104 and a “Coverage Status Legend” 2106.

The Pricing Snap Shot table restates the information about the Rx Impact plans found in the Prescription Drug Plan Pricing Snap Shot table 1924 (FIG. 19).

The Pricing Details table provides details on the costs associated with the given drugs that the user is entitled to view. In the example illustrated, the user is entitled to see the details of Drug Name #1 and Drug Name #2. The combined retail price of these drugs is $3347.62 (i.e. $1,725.29+$1,649.33). This is less than the displayed Estimated Total retail price of $4,055.48. Hence there are drugs that the user may not look at, presumably because they are used by the user's spouse or dependents over the age of 18.

Many of the row names and column names of the tables in the Rxlmpact Pricing Details folder page are hyperlinks. These have been discussed above. They generally link to additional explanatory information.

The Coverage Status Legend table 2106 provides an explanation of the meaning of the different coverage status codes.

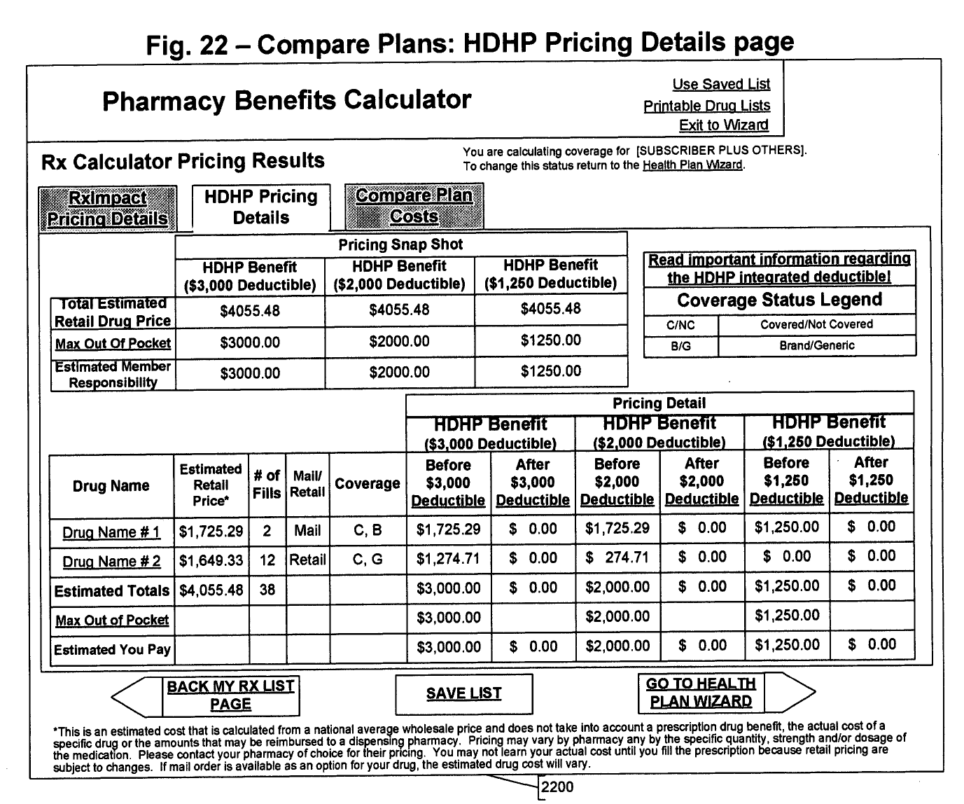

If a user clicks on the “HDHP Pricing Details” tab 2108 they will be taken to the “Compare Plans: HDHP Pricing Details” page. FIG. 22 illustrates the Compare Plans: HDHP Pricing Details page 2200.

The HDHP Pricing Details folder page of this page displays analogous information as the Rxlmpact Pricing Details folder page of FIG. 21.

If other types of health care plans are offered to a user, then provision for similar folder pages may be made in the Compare Plans page.

Referring to FIG. 9, if a user wishes to see if there is a low cost alternative to a given drug, they may click on a “View Alternatives” hyperlink 906 associated with said given drug. The user will then be taken to an Alternatives Pricing page.

An “Alternatives Pricing: Rxlmpact Pricing Details” page 2300 is shown in FIG. 23. The body of said page comprises folder tabs 2310 and folder pages 2314. Different folder tabs are provided for different types of health care plans (e.g. Rxlmpact and HDHP).

A folder page 2314 comprises a “Tell Me More About Alternatives” pop-up 2321, a “Coverage Status Legend” table 2322, a “Generic equivalent alternative” table 2320 and a “Therapeutic alternatives” table 2330.

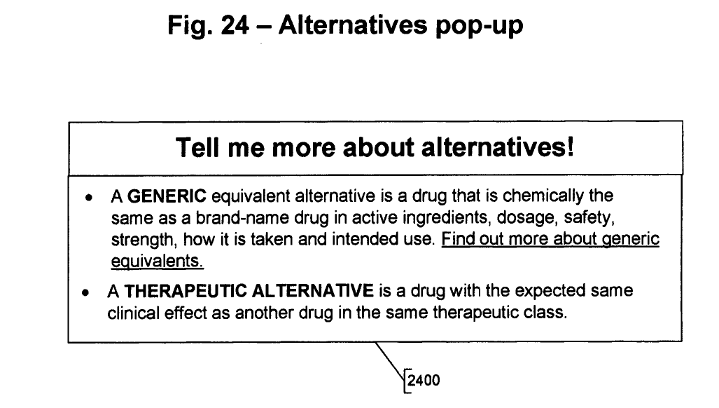

FIG. 24 illustrates the text 2400 of a “Tell Me More About Alternatives” pop-up.

The Coverage Status Legend table provides a key to the symbols describing the coverage of a given drug.

The Generic Equivalent Alternative table 2320 shows the costs of the original drug associated with the View Alternatives hyperlink that the user clicked on to enter the Alternatives Pricing page. The name of the original drug is stated in the first row of column “Drug Name” and also in the dynamic field [Drug selected from claims list].

If there are generic alternatives available to the original drug, they are listed in the rows below the original drug along with their pricing information. The Estimated Retail Price listed for a generic equivalent is the price associated with the most common prescription associated with the generic equivalent.

“Select” hyperlinks 2323 are provided to select one of the generic options over the original drug. The generic equivalent then replaces the original drug in the user's Drug List.

The Therapeutic Alternatives table 2330 shows the costs of the original drug associated with the View Alternatives hyperlink that the user clicked on to enter the Alternatives Pricing page. The name of the original drug is stated in the column “Drug Name” and also in the dynamic field [Drug selected from claims list].

If there are therapeutic alternatives available to the original drug, they are listed in the rows below the original drug along with their pricing information. The Estimated Retail Price listed for a therapeutic alternative is the price associated with a single fill of the most commonly prescribed quantity of the drug associated with said therapeutic alternative.

“Select” hyperlinks 2325 are provided to select one of the therapeutic options over the original drug. The therapeutic alternative then replaces the original drug in the user's Drug List.

The user may perform a similar price comparison for HDHP plans by selecting the HDHP Pricing Details folder tab 2312. The user will then be shown a HDHP Pricing Details folder page similar to the Rxlmpact Pricing Details folder page shown in FIG. 23.

Folder tabs and associated folder pages may be provided for other types of health plans as well.

When a user wishes to leave the Pharmacy Benefits Calculator, they click on an “Exit to Wizard” hyperlink (e.g. item 426, FIG. 4). They are then taken to a “Goodbye” page.

FIG. 25 illustrates a Goodbye page 2500 that a user would be taken to if their drug usage data were to be incorporated into their Health Plan Wizard. The body of the page comprises a combined dynamic field and hyperlink 2502, a Total Out-of-Pocket table 2504, and an option 2506 to use the drug list data in their Health Plan Wizard.

Combined dynamic field and hyperlink 2502 displays how many drug fills and refills the user has projected for the upcoming plan year. The hyperlink takes the user back to his/her My Drug List page (e.g. FIG. 9).

The Total Out-of-Pocket table 2504 restates a summary of the user's anticipated out-of-pocket pharmacy expenses under different health care plans for the upcoming plan year.

The option 2506 provides a means whereby the user can select to use their drug data in the Health Wizard (Yes!) or not (No). The option comprises a Continue hyperlink which takes the user back to the Health Plan Wizard.

A “Back to Rx Calculator” hyperlink 2508 is provided to allow the user to return to the page he/she was at prior to going to the Goodbye page.

FIG. 26 illustrates a Goodbye page 2600 that a user would be taken to if said user had to select one of the health plan options prior to returning to the Health Plan Wizard. This page is similar to FIG. 25 except that Select hyperlinks 2602 are provided for each health plan option. When the user selects a health plan option, they are then returned to the Health Plan Wizard.

### EXAMPLE

A Pharmacy Benefits Calculator according to the present invention was offered to the United States employees of a company during an open enrollment period for their health care coverage. The employees were offered a choice between health plan options that required copays for prescriptions depending upon the level a given drug was assigned to and health plan options that provided allowances for prescriptions where the allowances depended upon the Groups that given drugs were assigned to. The allowance plans were a new offering for the employees.

The employees had Internet access to a Pharmacy Benefits Calculator. They could enter the Pharmacy Benefits Calculator after first providing identification and security information to a Health Plan Wizard.

In the past, when new types of health care plans were offered to the employees but the employees did not have access to a Pharmacy Benefits Calculator, the first year acceptance rate of said new health care plans was about 5% or less.

In this instance, however, when the employees did have access to said Pharmacy Benefits Calculator, the first year acceptance rate was 18%.

The employees continued to have access to the Pharmacy Benefits Calculator after the expiration of the open enrollment period. Employees continued to use the Benefits Calculator at a rate of 10,000 times per month per 300,000 registered online accessible employees. Thus employees derived surprising utility, such as assisting with managing their ongoing prescription costs, from the invention.

### CONCLUSION

One of skill in the art will recognize that insurance is a regulated industry. One practicing the methods described and claimed herein will want to maintain compliance with all applicable local, state and federal regulations, to ensure that the insurance policy is properly presented to the insured, premiums are properly approved, underwriting properly occurs, all necessary regulatory approvals are in place, etc.

While particular embodiments of the present invention have been illustrated and described, it would be obvious to those skilled in the art that various other changes and modifications can be made without departing from the spirit and scope of the invention. Any of the aspects of the invention of the present invention found to offer advantages over the state of the art may be used separately or in any suitable combination to achieve some or all of the benefits of the invention disclosed herein.

1. A method for presenting a comparison of anticipated out-of-pocket pharmacy costs for a user under one or more pharmacy benefit plans, said method comprising:
a) accepting identification information and security information from said user;
b) verifying that said user may have access to the personal confidential information of said user, said verification being based at least in part on said identification information and said security information;
c) upon the success of said verification, retrieving at least a portion of said personal confidential information of said user;
d) calculating the anticipated out-of-pocket pharmacy costs of said user for each of said one or more pharmacy benefits plans, said calculation based at least in part on said personal confidential information; and
e) transmitting comparison data to said user, said comparison data comprising said anticipated out-of-pocket pharmacy costs under said one or more pharmacy benefits plans, wherein
at least one of said steps is at least in part carried out by an information system.

2. The method of claim 1 wherein said personal confidential information comprises at least a portion of the pharmacy claims data of said user, a dependent of said user or a family member of said user, said pharmacy claims being made against a pharmacy benefits plan provided by one or more insurance companies.

3. The method of claim 1 wherein said personal confidential information is under the control of a pharmacy benefits manager and wherein said method further comprises the steps of:
a) providing security information to said pharmacy benefits manager; and
b) receiving said personal confidential information from said pharmacy benefits manger if said security information meets a predetermined set of criteria.

4. The method of claim 1 wherein said personal confidential information comprises the personal pharmacy claims history of said user, said method further comprising:
a) transmitting to said user said pharmacy claims history;
b) providing a means for said user to modify said pharmacy claims history to produce anticipated pharmacy claims usage;
c) receiving from said user said anticipated pharmacy claims usage; and
d) calculating the modified anticipated out-of-pocket pharmacy costs of said user for each of said one or more pharmacy benefit plans, said calculation based at least in part on said anticipated pharmacy claims usage; and
e) transmitting said modified anticipated out-of-pocket pharmacy costs to said user.

5. The method of claim 4 wherein said means for said user to modify said pharmacy claims history comprises one or more of:
a) means for adding a script;
b) means for deleting a script;
c) means for amending a script;
d) means for replacing a script with a therapeutic alternative script.

6. The method of claim 4 wherein:
a) said pharmacy claims history comprises scripts; and
b) therapy codes are assigned to said scripts, said method further comprising the steps:
i. receiving an identification of a first script from said user; and
ii. providing a list of alternative scripts and their cost to said user, said alternative scripts being selected based on the therapy code assigned to said first script.

7. The method of claim 4 wherein the pharmacy claims history of said user comprises the pharmacy claims history of a dependent of said user, said dependent being less than 18 years old.

8. The method of claim 4 wherein:
a) said user has a spouse or a dependent older than 18; and
b) said pharmacy claim history does not comprise the pharmacy claim history of either said spouse or said dependent older than 18.

9. The method of claim 1 wherein said output data further comprises display data, said display data being:
a) transmitted to an electronic display device; and
b) being adequate for said electronic display device to present said anticipated output expenses to said user.

10. The method of claim 9 wherein:
a) said one or more pharmacy benefits plans comprise two or more genera of pharmacy benefits plans; and
b) said display data comprises color code data such that said out-of-pocket expenses are displayed in color coded cells on said electronic display device, the colors of said color coded cells corresponding to said genera of said pharmacy benefits plans.

11. The method of claim 9 wherein:
a) said one or more pharmacy benefits plans comprise at least one first pharmacy benefits plan that said user is currently enrolled in and at least one second pharmacy benefits plan that said user is not currently enrolled in;
b) said display data being adequate for said user to readily compare the out-of-pocket expenses of said at least one first pharmacy benefits plan and said at least one second pharmacy benefits plan; and
c) said method further comprises the step of providing a means for said user to enroll in one of said one or more pharmacy benefits plans for an upcoming benefit plan year.

12. The method of claim 11 wherein:
I. said first pharmacy benefits plan either:
a) provides Benefits which are based on copayments that a user would pay for a covered pharmacy expense; or
b) provides Benefits which are based on:
i. an integrated medical and prescription deductible in which a user would pay OOP costs for prescriptions until said integrated deductible is met; and,
ii. once said integrated deductible was met, said user would pay a percentage of a given prescription price, said percentage being less than 100; and
II. said second pharmacy benefits plan provides Benefits which are based on allowances which are provided to said user may pay, at least in part, the cost of a covered pharmacy expense.

13. The method of claim 12 wherein said second pharmacy benefits plan is configured such that the amount of said allowances is determined by the Group that a given script is assigned to, said Groups being assigned to scripts in accordance with the anticipated impact that said scripts will have on subsequent medical expenses covered by a health insurance policy in force on said user.

14. An electronic signal transmitted to a user, said electronic signal:
a) being adequate cause an electronic display device to present the anticipated out-of-pocket expenses of said user for each of two or more pharmacy benefits plans; and
b) being produced by steps comprising:
i. accepting identification information and security information from said user;
ii. verifying that said user may have access to the personal confidential information of said user, said verification being based at least in part on said identification information and said security information;
iii. upon the success of said verification, retrieving at least a portion of said personal confidential information of said user;
iv. calculating said anticipated out-of-pocket pharmacy costs of said user for each of said two or more pharmacy benefits plans, said calculation based at least in part on said personal confidential information; and
v. composing said electronic signal based on said calculation; and;
vi. transmitting said electronic signal to said user.

15. A computer readable medium, said computer readable medium comprising instructions for an electronic display device, said instructions being adequate for said electronic display device to receive and present comparison data comprising the anticipated out-of-pocket expenses of a user for each of one or more pharmacy benefits plans; said comparison data having been produced by the steps of:
a) accepting identification information and security information from said user;
b) verifying that said user may have access to the personal confidential information of said user, said verification being based at least in part on said identification information and said security information;
c) upon the success of said verification, retrieving at least a portion of said personal confidential information of said user;
d) calculating said anticipated out-of-pocket pharmacy costs of said user for each of said one or more pharmacy benefits plans, said calculation based at least in part on said personal confidential information; and
e) transmitting said comparison data to said user, said comparison data comprising said anticipated out-of-pocket pharmacy costs under said one or more pharmacy benefits plans.

16. An electronic display device, said electronic display device comprising instructions to receive and present comparison data comprising the anticipated out-of-pocket expenses of a user for each of one or more pharmacy benefits plans; said comparison data having been produced by the steps of:
a) accepting identification information and security information from said user;
b) verifying that said user may have access to the personal confidential information of said user, said verification being based at least in part on said identification information and said security information;
c) upon the success of said verification, retrieving at least a portion of said personal confidential information of said user;
d) calculating said anticipated out-of-pocket pharmacy costs of said user for each of said one or more pharmacy benefits plans, said calculation based at least in part on said personal confidential information; and
e) transmitting said comparison data to said user, said comparison data comprising said anticipated out-of-pocket pharmacy costs under said one or more pharmacy benefits plans.
